(19) United States
(12) Patent Application Publication
(10) Pub. No.: US 2015/0014375 A1
(43) Pub. Date: Jan. 15, 2015

(54) SURVEY SWING

(71) Applicant: TRIMBLE NAVIGATION, LIMITED, WESTMINSTER, CO (US)

(72) Inventors: Karl Forsberg, Arsta (SE); Niklas Briheim, Stockholm (SE); Kristoffer Svedulf, Skogas (SE); Robin Grieves, Stockholm (SE); Angela K. Vlasaty Peterson, Broomfield, CO (US); Johan Torbjorn Berggard, Stockholm (SE); Thomas William Bennet, Taby (SE)

(21) Appl. No.: 14/381,926

(22) PCT Filed: Feb. 28, 2013
(86) PCT No.: PCT/US13/28336

§ 371 Date: Aug. 28, 2014

Related U.S. Application Data
(60) Provisional application No. 61/605,039, filed on Feb. 29, 2012.

(51) Int. Cl. G01C 15/06

(52) U.S. Cl. CPC G01C 15/06
USPC 224/191

(57) ABSTRACT

A survey sling includes a sling coupled to a pole hook. A load-bearing pole is passed through a channel in the pole hook and into a central aperture. The pole hook is rotated so that the inner surfaces of the central aperture grip the pole hook. The load-bearing pole can then be ergonomically transported by lifting the sling. To disengage the pole hook from the load-bearing pole, the pole hook is rotated to distance the inner surface from the pole.

### RELATED APPLICATIONS

This application claims priority to U.S. Provisional Application No. 61/605,039, filed Feb. 29, 2012, which is incorporated by reference for all purposes.

### TECHNICAL FIELD

Embodiments of the present invention relate generally to ergonomic carrying and in particular to ergonomically transporting GPS devices mounted on elongated shafts.

### BACKGROUND

GPS devices are often used to survey land in order to quickly and accurately identify specific locations. In many instances, a GPS unit (and/or other equipment) is mounted on top of a pole, which must be carried by hand to several locations during the surveying process. Because measured locations are often located close to each other, surveyors tend to lift the pole using only their hands and arms. Repeatedly lifting the load-bearing pole quickly fatigues the surveyors, particularly if the terrain is uneven and requires the surveyor to repeatedly adjust the height at which the load-bearing pole is carried.

### SUMMARY

According to embodiments of the present invention, a survey sling includes a sling and a shaft coupler. The sling is worn about the waist or shoulders. A pole bearing a GPS unit is placed within an aperture in the shaft coupler. The edges of the aperture grip the pole as the shaft coupler is rotated into an engaged position. When the user lifts his or her body, those lifting forces are transferred through the survey sling to the pole. To release the pole from the shaft coupler, the shaft coupler is rotated to remove the edges of the aperture from the pole. While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a front perspective view of a shaft coupler, according to embodiments of the present invention.

FIG. 2 illustrates a top view of a shaft coupler with an angled channel, according to embodiments of the present invention.

FIG. 3 illustrates a top view of a shaft coupler with a narrowed channel, according to embodiments of the present invention.

FIG. 4 illustrates a top view of a shaft coupler with flexible shaft-retaining teeth, according to embodiments of the present invention.

FIG. 5 illustrates a top view of a shaft coupler with a rotating shaft-retaining member, according to embodiments of the present invention.

FIG. 6 illustrates a top view of a shaft coupler with a sliding shaft-retaining member, according to embodiments of the present invention.

FIG. 7 illustrates a front perspective view of a shaft coupler and a sling, according to embodiments of the present invention.

FIG. 8 illustrates a cross-sectional side view of a shaft coupler and a shaft, according to embodiments of the present invention.

FIG. 9 illustrates a cross-sectional side view of the shaft coupler and the shaft of FIG. 8, with the shaft coupler in an engaged position with respect to the shaft.

FIG. 10 depicts a shaft coupler, a sling, a shaft, and a controller unit attached to the shaft, according to embodiments of the present invention.

FIG. 11 depicts the shaft coupler, sling, shaft, and controller unit of FIG. 10, as well as a GPS unit and additional equipment attached to the shaft, according to embodiments of the present invention.

FIG. 12 depicts the shaft, the shaft coupler, and the sling of FIG. 10 with the shaft carried in a horizontal position, according to embodiments of the present invention.

FIG. 13 illustrates a top view of a shaft coupler with an enclosed aperture, according to embodiments of the present invention.

FIG. 14 illustrates a top view of a shaft coupler including a hinged lower portion in an open configuration, according to embodiments of the present invention.

FIG. 15 illustrates a top view of the shaft coupler of FIG. 14 in which the hinged lower portion is in a closed configuration, according to embodiments of the present invention.

FIG. 16 illustrates a top view of a shaft coupler including a lower shaft engagement portion separated from an upper shaft engagement portion.

FIG. 17 illustrates a top view of the shaft coupler of FIG. 16 in which the lower shaft engagement portion is coupled to the upper shaft engagement portion

FIG. 18 illustrates a perspective view of a shaft coupler including a spring loaded shaft retaining member, according to embodiments of the present invention.

FIG. 19 illustrates the shaft coupler of FIG. 18 coupled with a dual sided sling, according to embodiments of the present invention.

FIG. 20 illustrates a rear view of the dual sided sling of FIG. 19.

FIG. 21 illustrates a perspective view of a shaft coupler including an angled receiving aperture, according to embodiments of the present invention.

FIG. 22 illustrates a top perspective view of the shaft coupler of FIG. 21 engaging a shaft.

FIG. 23 illustrates a side perspective view of the shaft coupler of FIG. 21 engaging a shaft.

FIG. 24 illustrates a top view of the shaft coupler of FIG. 21 coupled with a dual sided sling, according to embodiments of the present invention.

FIG. 25 illustrates a top perspective view of a shaft coupler of FIG. 21 including a resilient shaft retaining member attached thereto.

FIG. 26 illustrates a side perspective view of the shaft coupler of FIG. 25.

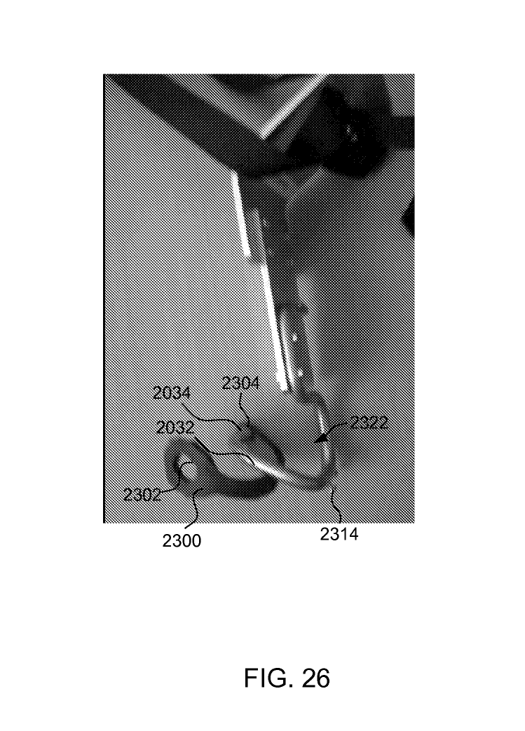

FIG. 27 illustrates an opposite side perspective view of the shaft coupler of FIG. 25.

FIG. 28 illustrates a top view of the shaft coupler of FIG. 25 coupled with a dual sided sling and a top view of a single sided sling, according to embodiments of the present invention.

FIG. 29 illustrates a perspective view of a shaft coupler with an angled receiving aperture, according to embodiments of the present invention.

FIG. 30 illustrates a lower perspective view of the shaft coupler of FIG. 29 as it moves into engagement with a shaft, according to embodiments of the present invention.

FIG. 31 illustrates a perspective view of the shaft coupler of FIG. 30 as it rotates with respect to the shaft.

FIG. 32 illustrates an upper perspective view of a shaft coupler that includes a proximal clamp member, according to embodiments of the present invention.

FIG. 33 illustrates a perspective view of a shaft coupler with a locking mechanism coupled to a proximal clamp member, according to embodiments of the present invention.

FIG. 34 illustrates a rear perspective view of the shaft coupler of FIG. 33.

### DETAILED DESCRIPTION

Embodiments of the present invention include a survey sling that uses a shaft coupler to engage and lift a load-bearing shaft. The sling is placed on the shoulders or the hips of the surveyor, who uses the survey sling to carry the load-bearing shaft in a more ergonomic fashion. For example, a surveyor may need to survey a field using a GPS unit mounted onto a pole. The survey sling enables the surveyor to lift and carry the pole bearing the GPS unit without lifting and carrying the entire load with his or her arms. This arrangement also helps stabilize the pole while it is being moved. Other embodiments are used for transporting various shafts in any number of contexts for any number of duties.

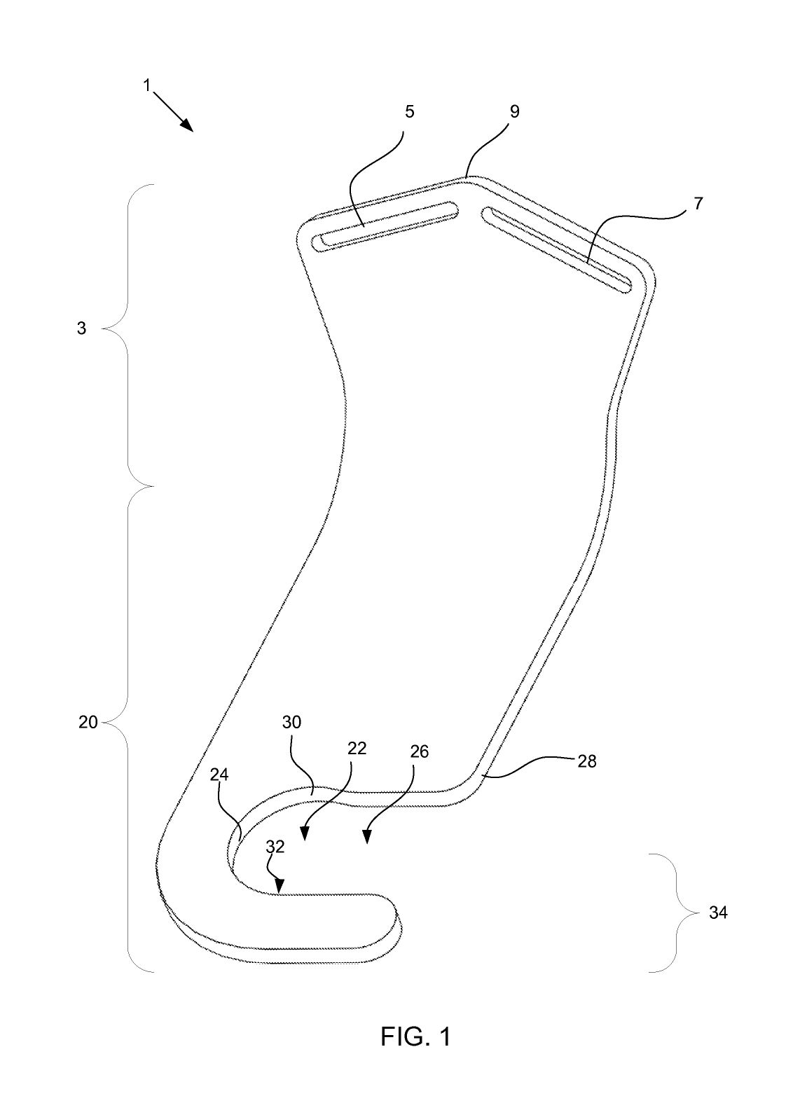

In some embodiments, the survey sling includes a shaft coupler 1, illustrated in FIG. 1. The shaft coupler includes a sling attachment section 3 that may include various mechanisms for attaching the shaft coupler 1 to the sling. In FIG. 1, the sling attachment section 3 includes two sling slots 5, 7. Each side of a sling may be threaded through a sling slot. The mechanisms for attaching the sling attachment section 3 to the sling may include releasable mechanisms, such as snaps, buttons, Velcro™, buckles, and the like, or may include more permanent mechanisms, such as stitching, adhesives, and the like. The sling attachment section 3 may include more than two slots or a combination of one or more permanent and/or releasable mechanisms. In some embodiments, the mechanisms for attaching the sling to the sling attachment section 3 allow the sling attachment section 3 to rotate with respect to the sling.

As shown in FIG. 1, the sling slots 5, 7 may be placed in a non-parallel configuration to accommodate the angle at which the sling ends reside when placed on the surveyor. As also shown in FIG. 1, the sling attachment section 3 may include an angled upper edge 9. The angle of the angled upper edge 9 may match the angles of the sling slots 5, 7, or may be different than the angles of the sling slots 5, 7. In some embodiments, the sling slots 5, 7 and the angled upper edge 9 may be adjustable. In some embodiments, the sling attachment section 3 does not include an angled upper edge 9 and angled sling slots 5, 7, but instead connects to the sling with a rivet or a similar device.

The shaft coupler 1 also includes a shaft engagement section 20. In some embodiments, the shaft engagement section 20 and the sling attachment section 3 are non-coplanar. Angling the shaft engagement section 20 with respect to the sling attachment section 3 enables the shaft engagement section 20 to remain at or near a position in which the shaft engagement section 20 can engage a shaft, as explained below in more detail, without necessitating large movements to raise the sling attachment section 20 each time the surveyor needs to carry the shaft. In some embodiments, that angle is approximately 120-130 degrees, but could range from 90-140 degrees.

According to some embodiments, the shaft engagement section 20 includes a receiving aperture 22. The receiving aperture 22 is defined by an inner surface 24. In some embodiments, a channel 26 connects the inner surface 24 to an outer surface 28 of the shaft engagement section 20.

In some embodiments, to engage a shaft, the shaft engagement section 20 is placed near the shaft in a substantially orthogonal position. The shaft engagement section 20 is moved substantially within that orthogonal plane so that the shaft passes through the channel 26 and into the receiving aperture 22. The shaft engagement section 20 is then rotated to an engaged position so that an upper edge 30 of the receiving aperture 22 contacts and frictionally engages one side of the shaft while a lower edge 32 of the receiving aperture 22 contacts and frictionally engages an opposite side of the shaft. To assist in creating that frictional engagement, in some embodiments the shaft engagement section 20 is heavier than the sling attachment section 3, such that the additional weight creates torque to rotate the shaft engagement section 20 into a gripping alignment with the shaft. Those rotational forces can be increased if the shaft engagement section 20 is heaviest at or near the end of the shaft engagement section 20 furthest from the sling attachment section 3. In addition, the upper edge 30 and the lower edge 32 may be formed from or covered by a friction-enhancing material. The friction-enhancing materials, for example, rubber, semi-hard plastics, hard plastics, silicon, materials with rough surfaces, and the like, may vary based on the characteristics of the outer surface of the shaft.

Once the shaft engagement section 20 has gripped the shaft, the surveyor lifts the shaft using the sling. Specifically, the surveyor raises his or her hips or shoulders to raise the sling, which raises the shaft coupler 1. That lifting force is transferred to the shaft engagement section 20, which increases the frictional forces between the edges 30, 32 of the receiving aperture 22 and the shaft. The shaft is lifted with the shaft coupler 1.

According to some embodiments, the shaft engagement section 20 may grip the shaft at any location along the shaft. This allows surveyors of many heights to carry shafts of many heights. In addition, in some embodiments the shaft engagement section 20 is placed above or below the center of gravity of the shaft (taking into account any load on the shaft). The torque generated by the lifting motion will generate rotational forces that can further secure the shaft within the receiving aperture 22. For example, a slight rotation allows a lower portion 34 of the shaft engagement section 20 to directly bear some of the weight of the shaft and its load. The rotation of the shaft may be controlled or directed by a surveyor's hand holding the shaft.

To disengage the shaft coupler 1 from the shaft, the surveyor either raises the shaft engagement section 20 (e.g., the lower portion 34 of the shaft engagement section 20) or lowers the sling attachment section 3 so that the shaft coupler 1 rotates with respect to the shaft into a disengaged position. Either displacement will distance the upper edge 30 and the lower edge 32 of the receiving aperture 22 from the shaft. The shaft coupler 1 may be disengaged when the shaft is resting with one end on the ground or the shaft coupler 1 may be disengaged while the shaft is above the ground, causing the shaft to slide down to the ground.

Thus, some embodiments of the present invention provide a simple and efficient way to quickly connect and disconnect the shaft to the shaft coupler 1, and therefore to the sling and the hips or shoulders of the surveyor. For example, according to some embodiments, the surveyor wearing the sling about his or her shoulders holds the shaft with one hand in a substantially vertical position. In some embodiments, the hand holding the shaft is the hand on the opposite side from the shoulder over which the sling is placed. The surveyor uses his or her other hand to place the shaft coupler 1 in a substantially horizontal position with the channel 26 near the shaft. The surveyor then moves the shaft coupler 1 so that the shaft passes through the channel 26 and into the receiving aperture 22.

The surveyor then rotates the shaft coupler 1 to engage the upper edge 30 and the lower edge 32 of the receiving aperture 22 with the shaft. In some embodiments, the weight and configuration of the shaft coupler 1 contributes torque for that rotation as the shaft coupler 1 pivots about its connection to the sling. In some embodiments, the surveyor lowers his or her shoulders before locating the shaft coupler 1 in a substantially horizontal position with the channel 26 near the shaft, and then raises his or her shoulders once the shaft resides within the receiving aperture. This will lift the sling attachment section 3 and will rotate the shaft coupler 1 into the engaged position. In other embodiments, the surveyor places the shaft within the receiving aperture 22 and then lowers his or her shoulders to lower the shaft coupler 1 down the shaft. When the surveyor raises his or her shoulders, the lifting motion will raise the sling attachment section 3 and rotate the shaft coupler 1 into the engaged position.

The surveyor then carries the shaft to the next location, carrying the load on his or her hips or shoulders and using one hand (e.g., the hand opposite the side of the shoulder on which the sling is placed) simply to add additional stability. In some embodiments, because the weight of the shaft is transferred to the shoulders or the hips, the full strength of the surveyor's arm may be used solely for stabilization. In addition, originating the lifting forces from the shoulders of the surveyor provides greater stability as the surveyor passes over uneven terrain, as the weight may be borne close to the surveyor's natural center of gravity.

According to some embodiments, the frictional engagement between the edges 30, 32 of the receiving aperture and the outer surface of the shaft allow the surveyor to quickly raise the shaft and engage the shaft coupler 1 at a lower position on the shaft. Specifically, the surveyor uses one hand to lift the shaft upwardly. In those embodiments in which the sling is placed over a user's shoulder, the hand on the side opposite the shoulder on which the sling is placed is used to lift the shaft. The frictional engagement will cause the shaft coupler 1 to rotate into a disengaged position, allowing the pole to freely slide up through the receiving aperture. To re-engage the shaft coupler, the surveyor lowers the shaft slightly. That movement causes the shaft couplers to rotate back into the engaged position on a lower section of the shaft. That same process of disengagement and reengagement can also be performed by hand, for example, when the surveyor manually lifts the lower portion 34 of the shaft engagement section 20, slides the shaft upwards, and then lowers the lower portion 34 of the shaft engagement section 20 (again, either by slightly lowering the shaft or by manually lowering the lower portion 34). In those embodiments in which the sling is placed over a user's shoulder, the hand on the same side as the shoulder on which the sling is placed is used to manually manipulate the lower portion 34 of the shaft engagement section 20, allowing the opposite hand to steady or lift the shaft during this process. In other embodiments, the hand on the same side as the shoulder on which the sling is placed is used to lift and steady the shaft while the opposite hand is used to manually manipulate the lower portion 34 of the shaft engagement section 20.

Because the shaft resides within the receiving aperture 22, the shaft may be carried in a substantially vertical position or may be rotated into a more horizontal position, such that the lower portion 34 of the shaft engagement section 20 will directly bear most or all of the weight of the shaft and its load.

To disengage the shaft coupler 1 from the shaft, the surveyor simply lowers his or her shoulders with the bottom of the shaft resting on the ground. This removes the lifting forces and allows the shaft coupler (specifically the sling attachment section 3) to fall, such that the shaft coupler rotates back to a disengaged position (i.e., the substantially horizontal position). The surveyor may then move the shaft coupler 1 away from the shaft. The ease of engagement and disengagement also allows the surveyor to quickly identify ideal locations on the shaft for attaching the sling, for example, near the center of gravity of the shaft (including any attached load). Engaging the shaft coupler 1 near that center of gravity will minimize efforts needed to prevent unwanted shaft rotation. In other embodiments, the ideal locations for attaching the shaft coupler 1 to the sling are chosen based on the surveyor's height, ground conditions (e.g., if the terrain is rough and requires the shaft to have a higher clearance over the ground), the weight distribution of the shaft and any attached equipment, as well as other factors.

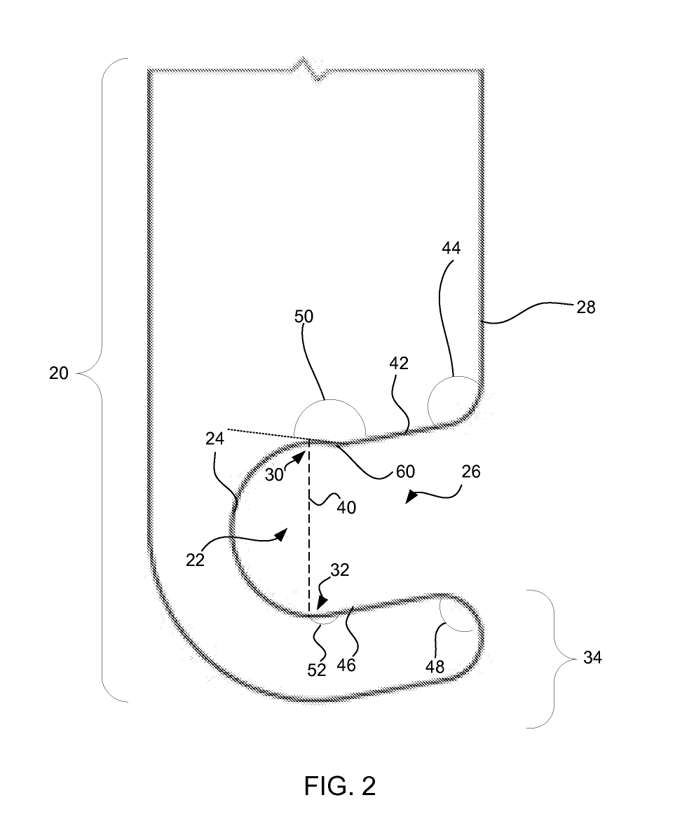

According to some embodiments, for example, those illustrated in FIGS. 2-4, the receiving aperture 22 and the channel 26 may be placed in various arrangements in order to secure the shaft within the receiving aperture 22. As shown in FIG. 2, the receiving aperture 22 forms a shape that matches the cross-sectional shape of the shaft. For example, if the shaft is a cylinder, the receiving aperture 22 has a circular shape. In those embodiments, the diameter 40 of the receiving aperture 22 is slightly larger than the diameter of the shaft. For example, if the diameter of the shaft is 2 cm, then the diameter 40 of the receiving aperture 22 could be approximately 2.2 cm. In some embodiments, the diameter 40 of the receiving aperture 22 ranges from approximately 4-8% larger than the diameter of the shaft. In some embodiments, the diameter 40 of the receiving aperture may range from 3.5 cm to 4.0 cm, or may have a wider range. This range may vary based on the shaft materials, the shaft coupler 1 materials, the properties of any friction-enhancing materials added to the shaft coupler 1, the thickness of the inner surface 24 of the receiving aperture, and/or the angle at which the shaft engagement section 20 must rotate before engaging the shaft.

The thickness of the shaft coupler 1, and in particular the shaft engagement section 20 or the inner surface 24 of the receiving aperture 22, may vary according to various embodiments. For example, in some embodiments, inner surface 24 is razor thin. In other embodiments, the inner surface ranges from 4 mm to 8 mm in thickness. In yet other embodiments, the inner surface is an elongated surface with a thickness of up to 5 cm or more. In some embodiments, the thickness of the inner surface 24 of the receiving aperture 22 is different from the thickness of other portions of the shaft engagement section 20 or the shaft coupler 1.

These and other factors may vary in a correlated manner to ensure that the sling engagement section engages the shaft in a desired fashion. For example, if a surveyor wanted less rotation before the shaft engagement section 20 engages the shaft, the receiving aperture 20 could have a smaller diameter 40. If the surveyor wanted a thinner shaft coupler 1, the sling engagement section 20 would rotate further to engage the shaft. If friction-enhancing materials are used, the shaft engagement section 20 may need to be rotated to a smaller degree. Other factors influencing the shaft engagement may also be varied accordingly.

In some embodiments, the channel 26 has a different shape than the receiving aperture 22. For example, as shown in FIG. 2, the channel 26 is a straight channel extending from the receiving aperture 22 to the outer surface 28 of the shaft engagement section 20. In other embodiments, the channel 26 is a curved channel, a channel that expands from the receiving aperture 22 to the outer surface 28, a channel that narrows from the receiving aperture 22 to the outer surface 28, or a combination of those or others.

The channel 26 may intersect the receiving aperture 22 and the outer surface 28 of the shaft engagement section 20 at various angles. In some embodiments, an upper channel surface 42 intersects the outer surface 28 at an obtuse angle 44. In other embodiments, the upper channel surface 42 intersects the outer surface 28 at an orthogonal or acute angle. The lower channel surface 46 may likewise intersect the outer surface 28 at an angle 48 that is acute, orthogonal, or obtuse. In some embodiments, the angle 44 and the angle 48 are substantially the same or may be complementary angles. In some embodiments, the angle 44 and the angle 48 are distinct angles without a particular relationship. The channel 26 illustrated in FIG. 2 angles toward the sling attachment section 3 as it extends towards the outer surface 28, which helps retain the shaft as it is transported. In other embodiments, the channel 26 angles away from the sling attachment section 3 as it extends towards the outer surface 28.

The upper channel surface 42 also intersects the inner surface 24 of the receiving aperture 22 at particular angles. For example, as shown in FIG. 2, those surfaces meet at an angle 50 that is less than 180 degrees. The lower channel surface 46 may intersect the inner surface 24 at a straight angle 52. The angles 50, 52 may vary to include acute, orthogonal, straight, obtuse, or reflex angles.

In some embodiments, the channel 26 may join with the receiving aperture 22 in such a way that one or more steps 60 are defined, as shown in FIG. 2. The steps 60 may be located at the intersection of the upper channel surface 42 and the inner surface 24 of the receiving aperture 22 and/or at the intersection of the lower channel surface 46 and the inner surface 24 of the receiving aperture 22. In other embodiments, the steps 60 are located in the channel 26. The steps 60 may help retain the shaft within the receiving aperture 22.

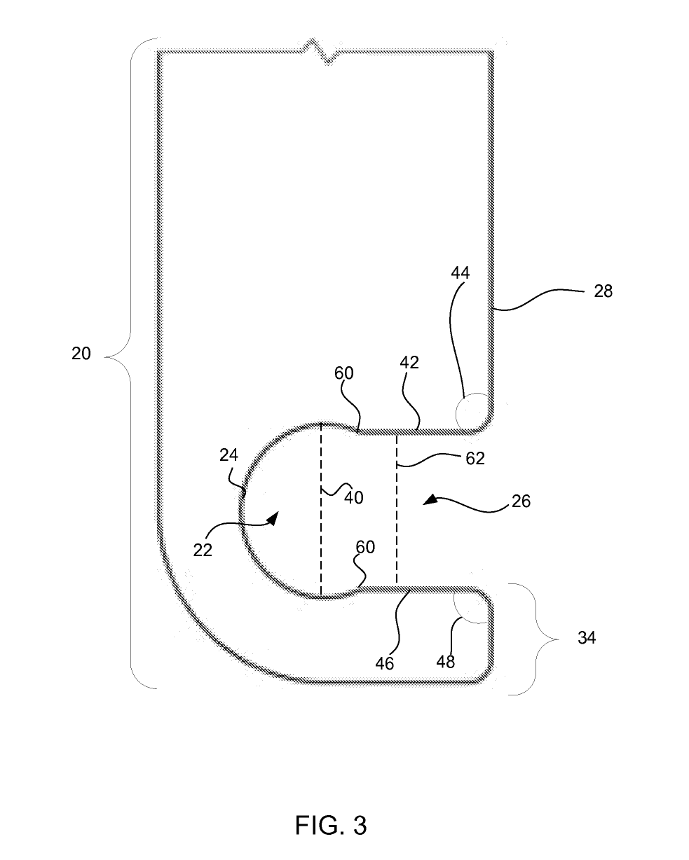

As shown in FIG. 3, in some embodiments the channel 26 intersects the outer surface 28 of the shaft engagement section 20 at orthogonal angles 44, 48. To help secure the shaft within the receiving aperture 22, the width 62 of the channel 26 is less than the width or diameter 40 of the receiving aperture 22. This creates steps 60 that help retain the shaft within the receiving aperture 22.

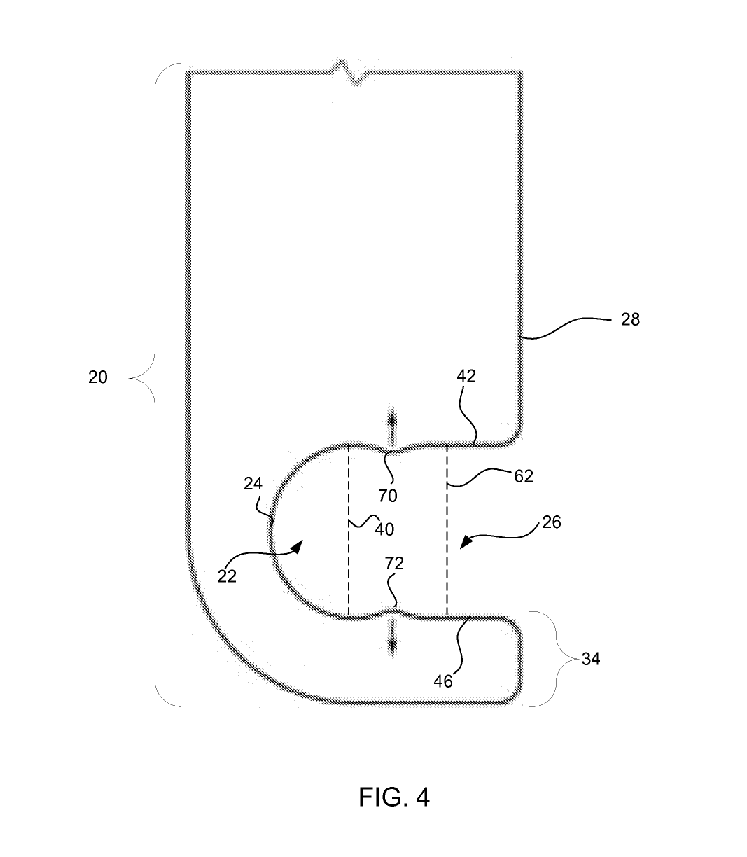

As shown in FIG. 4, in some embodiments the width 62 of the channel 26 may be approximately equal to the diameter 40 of the receiving aperture 22. To help retain the shaft in the receiving aperture 22, two teeth 70, 72 are placed at or near the intersection of the channel 26 and the receiving aperture 22 and extend into the channel 26 and/or the receiving aperture 22. In some embodiments, the intersection of the upper channel surface 42 (and/or lower channel surface 46) with the inner surface 24 of the receiving aperture 22 defining the teeth 70, 72. The teeth 70, 72 may be formed of different materials than the rest of the shaft engagement section 20. In some embodiments, the teeth 70, 72 are formed of resilient material and may be angled towards the receiving aperture 22. In those embodiments, the teeth 70, 72 flex as the shaft passes over the teeth and into the receiving aperture 22. Once the shaft passes the teeth 70, 72, the teeth return to their original, unflexed, position and help to retain the shaft within the receiving aperture.

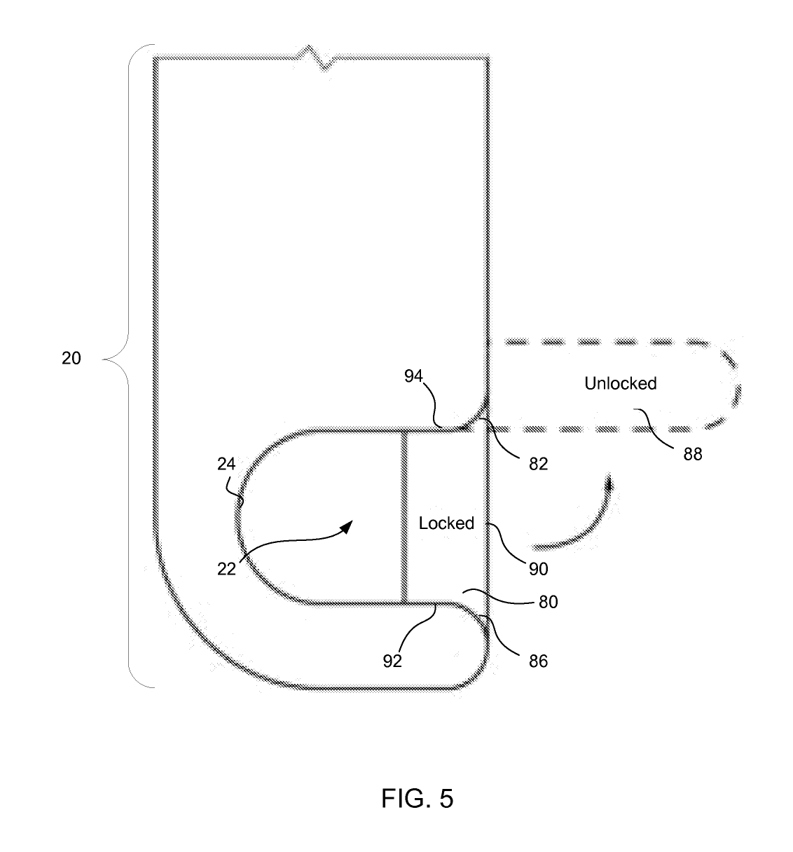

As shown in FIG. 5, in some embodiments the shaft engagement section 20 may include a shaft retaining member 80. The shaft retaining member 80 is rotatably coupled to the shaft engagement section 20 at a proximal end 82, for example, by a spring-loaded pin joint. The shaft retaining member 80 includes a locking mechanism (not shown) such as, for example, a clip, at a distal end 86. The shaft retaining member 80 is moved from an unlocked position 88 into a locked position 90, and vice versa. The locking mechanism may secure the shaft retaining member 80 in the locked position 90 by engaging a lower surface 92 of the shaft engagement section 20. In other embodiments, the locking mechanism engages an upper surface 94 of the shaft engagement section 20 at or near the proximal end 82 of the shaft retaining member 80 to prevent the shaft retaining member 80 from rotating. In yet other embodiments, the locking mechanism engages the joint to prevent rotation. In the locked position 90, the shaft retaining member 80 may help distribute retaining forces more evenly and lessen the stress placed on the inner surface 24 of the receiving aperture 22, for example, on a side opposite the shaft retaining member 80.

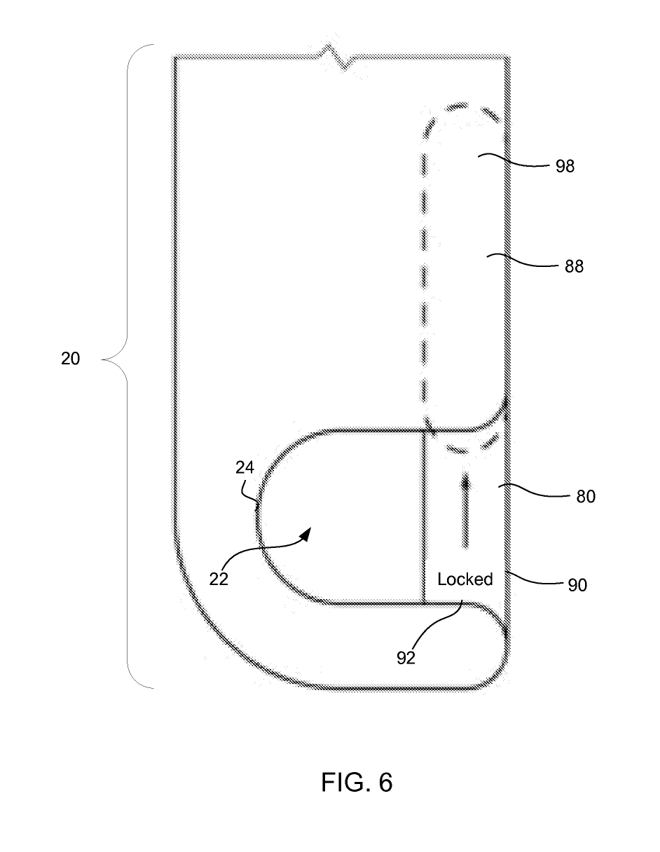

As shown in FIG. 6, in some embodiments the shaft retaining member 80 may slide from an unlocked position 88 to a locked position 90, and vice versa. In those embodiments, the locking mechanism may engage a lower surface 92 of the shaft engagement section 20 to secure the shaft retaining member 80 in the locked position 90. To accommodate the shaft retaining member 80 in its unlocked position 88, the shaft coupler 1 may include a retaining member aperture 98.

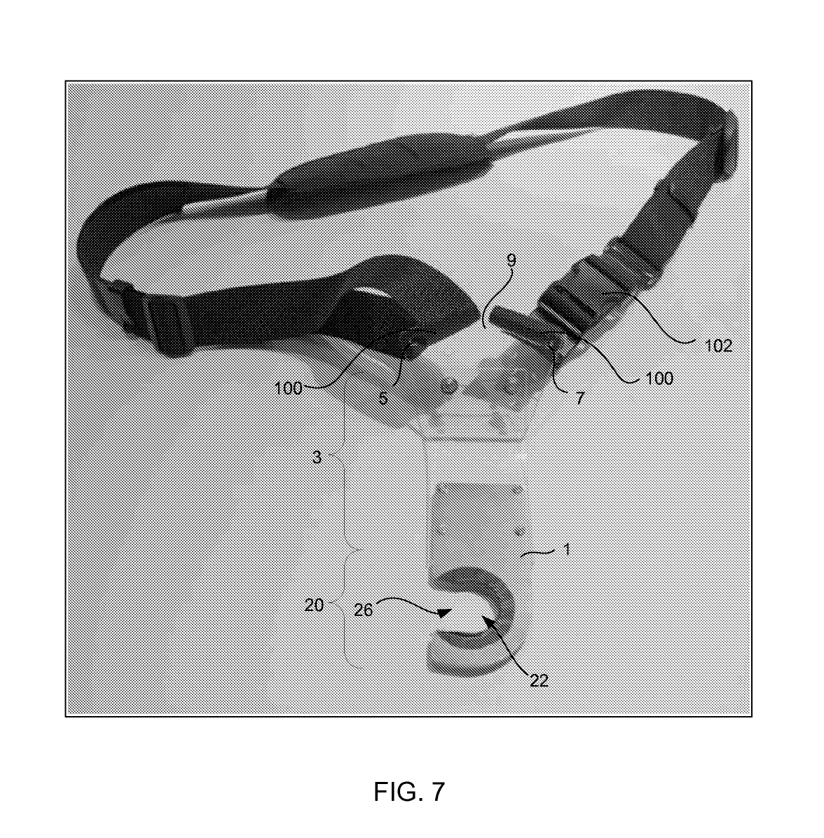

As shown in FIG. 7, the shaft coupler 1 is attached to a sling 100. In some embodiments, the shaft coupler 1 is releasably secured to the sling 100 in multiple configurations. For example, the shaft coupler 1 may be releasably secured to the sling 100 in a first configuration in which the channel 26 extends to the left side of the shaft coupler 1, as shown in FIG. 7. That same shaft coupler may also be releasably secured to the sling 100 in a second configuration in which the channel 26 extends to the right side of the shaft coupler 1.

The sling 100 may also include a buckle 102 or other mechanism by which a surveyor may quickly remove the sling from his or her body.

Various materials may be used for the shaft coupler 1. For example, the shaft coupler 1 (e.g., the upper edge 30 and the lower edge 32) may be formed of a rigid material, such as plastic, metal, or a combination of the two. In some embodiments, the shaft coupler 1 is unitarily formed of a single piece of metal. In some embodiments, the shaft coupler 1 does not permit flexion of the upper edge 30 or the lower edge 32 with respect to each other.

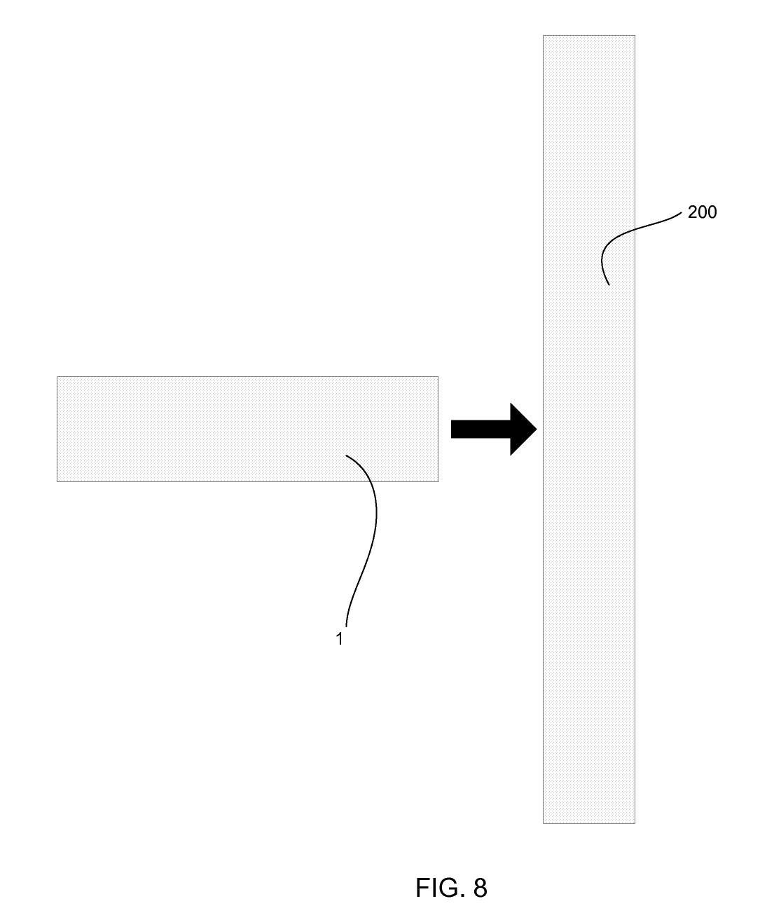

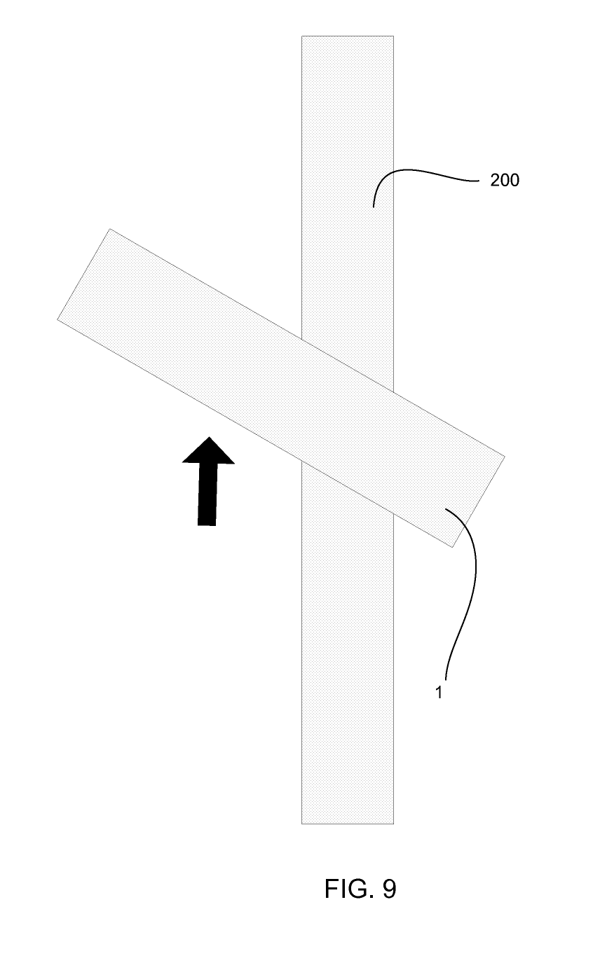

As shown in FIGS. 8 and 9, the shaft coupler 1 rotates with respect to the shaft in order to frictionally engage the edges 30, 32 of the receiving aperture 22 with the shaft.

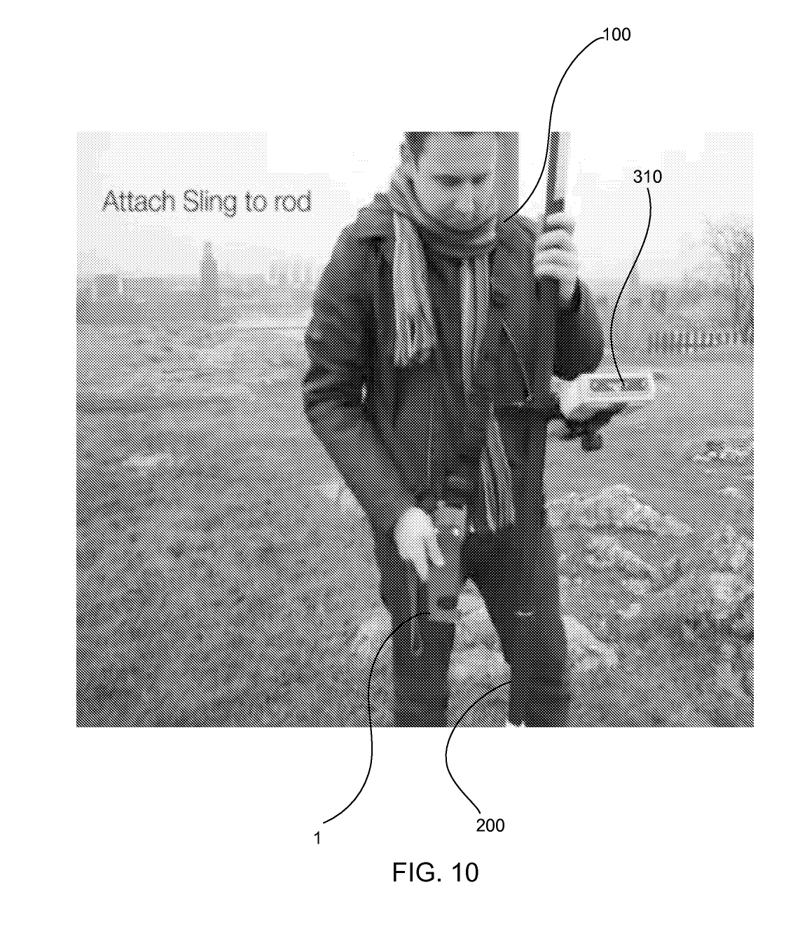

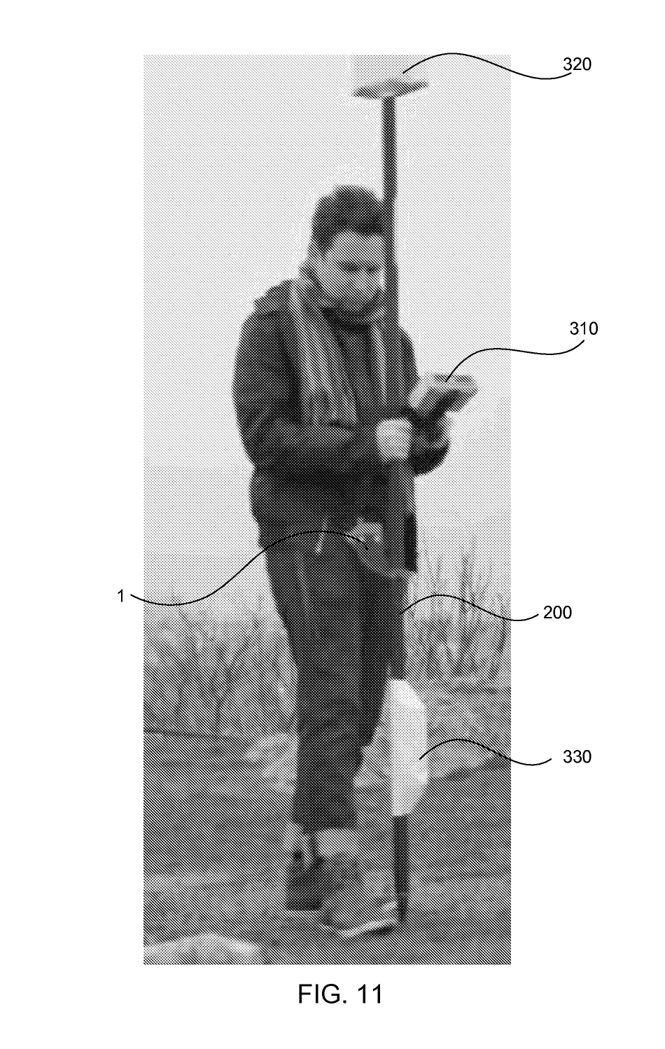

As shown in FIG. 10, a computer or controller 310 may be attached to the shaft 200. As shown in FIG. 11, the shaft 200 may also have attached a GPS unit 320 and other cargo 330. Other equipment may also be secured to the shaft, such as data transmitters, battery packs, and the like. The shaft 200 may be equipped with a wide range of cargo as required by a particular task or environment.

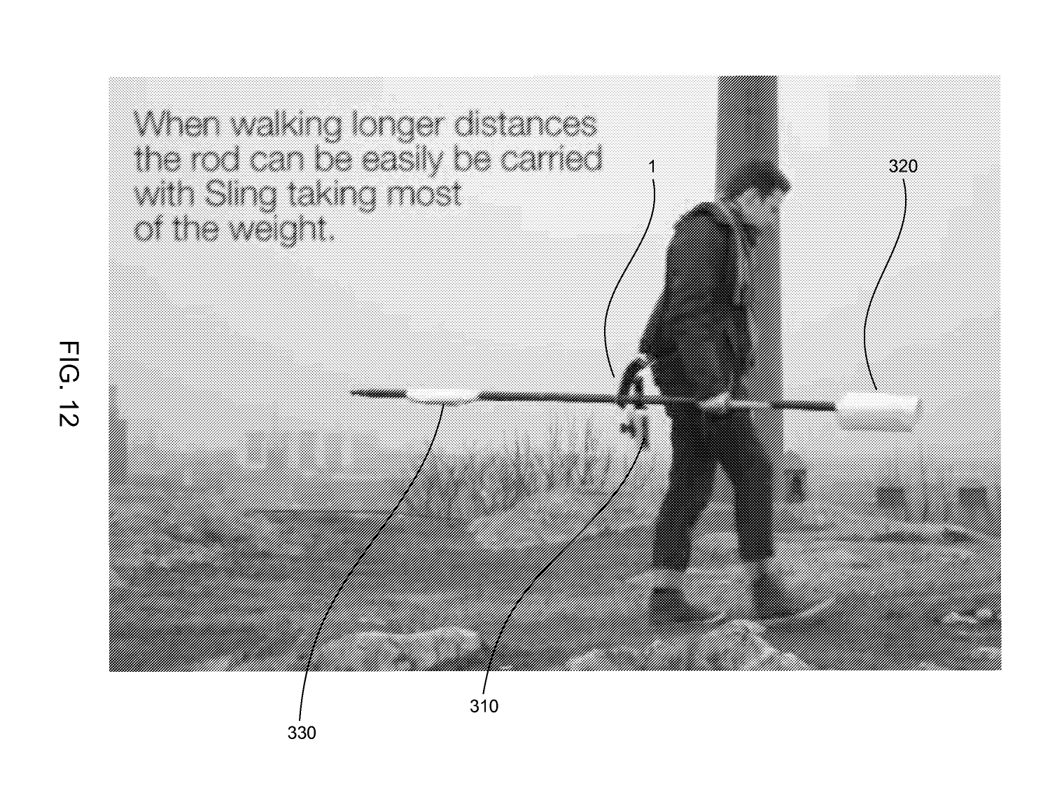

As shown in FIG. 12, the shaft 200 may be carried in a horizontal position, with the sling coupler 1 directly bearing the weight of the shaft 200 and attached equipment 310, 320, and 330.

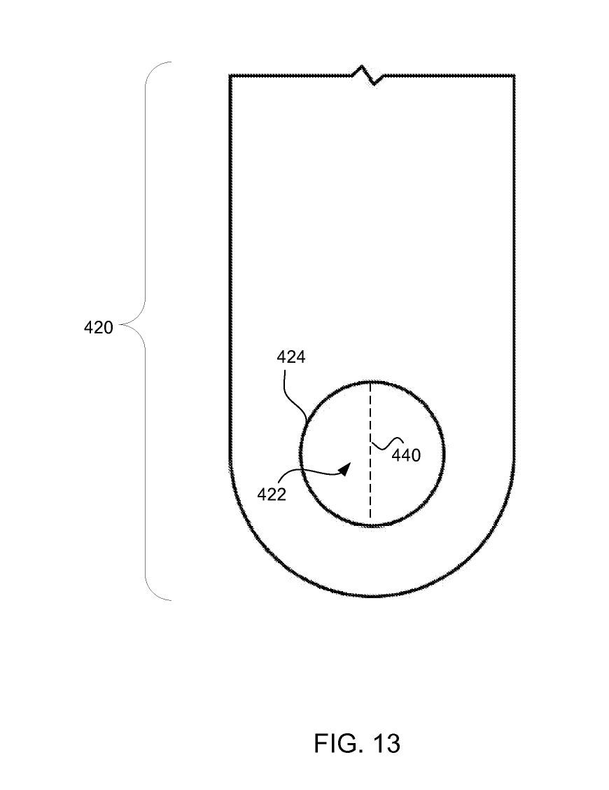

As shown in FIG. 13, and according to some embodiments, a shaft engagement section 420 includes a receiving aperture 422. The receiving aperture 422 forms a closed loop defined by an inner surface 424. The shape of the receiving aperture 422 may correspond to the cross-sectional shape of the shaft. For example, the diameter 440 of the receiving aperture 422 may be equal to or slightly larger than the diameter of the shaft. In those embodiments, the shaft engagement section 420 is placed in an orthogonal position with respect to a longitudinal axis of the shaft. One end of the shaft is passed into the receiving aperture 420, and the shaft is pushed or pulled through the receiving aperture 420 until the shaft engagement section 420 reaches a desired location on the shaft. The shaft engagement section 420 is then rotated, either manually or through an initial frictional engagement between the inner surface 424 (or portions thereof) and the outer surface of the shaft. This rotational movement will increase the engagement between the shaft engagement section 420 and the shaft.

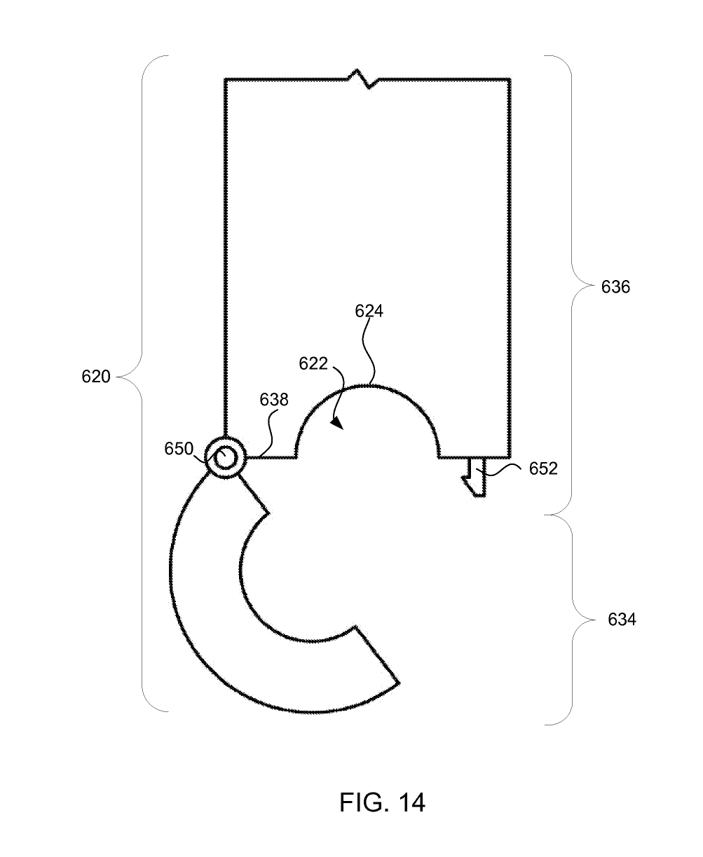

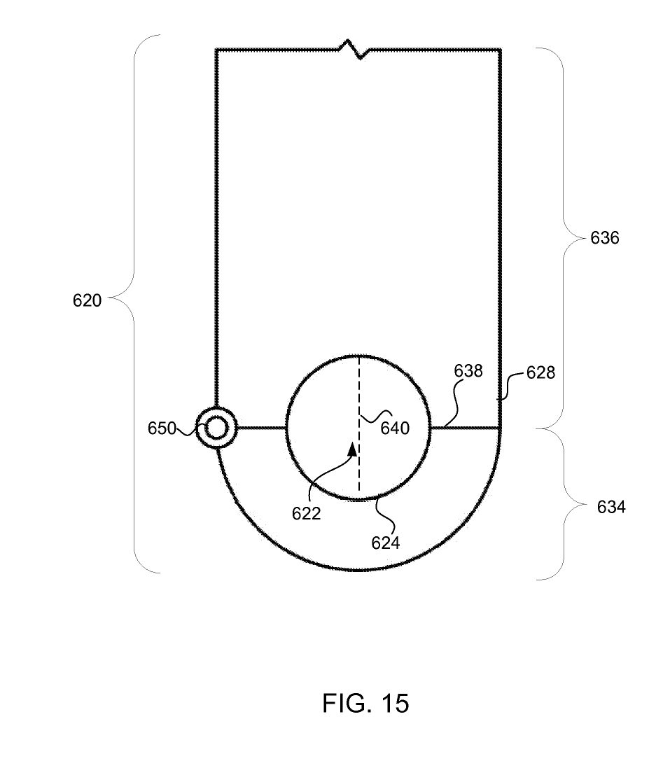

As shown in FIGS. 14 and 15, according to some embodiments a shaft engagement section 620 includes a receiving aperture 622 defined by a lower shaft engagement section 634 and an upper shaft engagement section 636. In some embodiments, the lower shaft engagement section 634 and the upper shaft engagement section 636 are only partially separated, for example, by an boundary 638 that extends from an outer surface 628 of the shaft engagement section 620 to an inner surface 624 of the receiving aperture 622. The boundary 638 enables the lower shaft engagement section 634 and the upper shaft engagement section 636 to partially separate and allow the shaft to pass through the boundary 638 and into the receiving aperture 622. In other embodiments, the boundary 638 extends across the entire shaft engagement section, completely separating the lower shaft engagement section 634 from the upper shaft engagement section 636. In those embodiments, the lower shaft engagement section 634 and the upper shaft engagement section 636 may each be connected by a hinge 650, allowing the lower shaft engagement section 634 to rotate between an open configuration (as shown in FIG. 14) and a closed configuration (as shown in FIG. 15). To engage the shaft, the lower shaft engagement section 634 is rotated into the open configuration and the shaft is placed within the receiving aperture 622. The lower shaft engagement section 634 is then moved up into the closed configuration, thereby securing the shaft within the receiving aperture 622. In some embodiments, the upper shaft engagement section 636 includes a securing mechanism 652 that releasably locks the lower shaft engagement section 634 in the closed configuration. The shaft engagement section 620 may then be rotated so that the inner surface 624 of the receiving aperture 622 engages the outer surface of the shaft, as explained above. The securing mechanism 652 may be released by the push of a button, the pull of a lever, or the like.

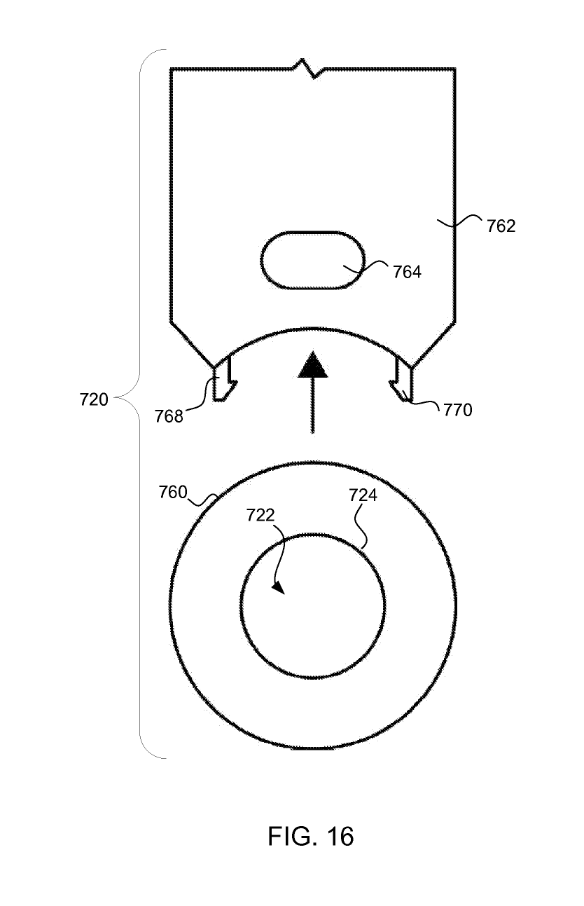

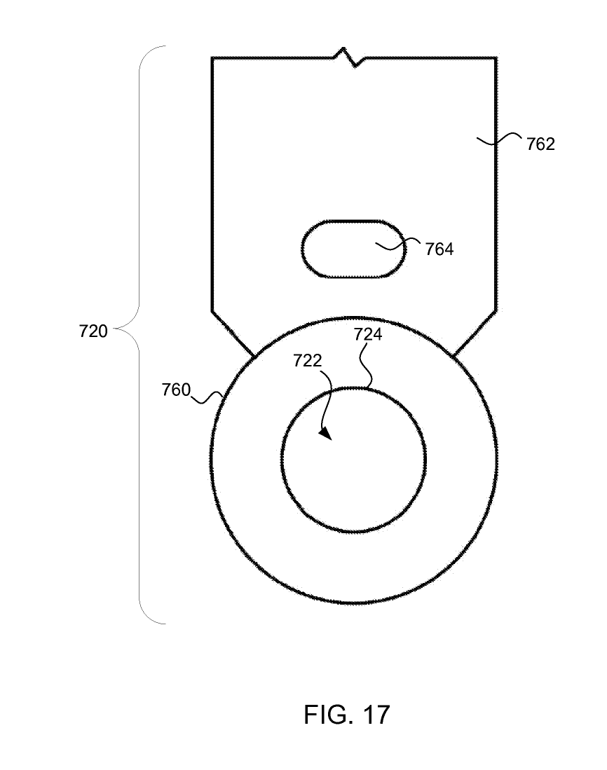

As shown in FIGS. 16 and 17, and according to some embodiments, a shaft engagement section 720 includes a lower shaft engagement portion 760 and an upper shaft engagement portion 762. Those portions 760, 762 may be separately formed from the same material or from different materials. In some embodiments, the lower shaft engagement portion 760 fully encompasses the receiving aperture 722, whose inner surface 724 forms a closed loop. The shaft may be passed through the receiving aperture 722 until the lower shaft engagement portion 760 is at a desired location on the shaft. The shaft is then placed near the upper shaft engagement portion 762, such that the lower shaft engagement portion 760 couples with the upper shaft engagement portion 762. In some embodiments, the upper shaft engagement portion 762 includes securing mechanisms 768, 770 that releasably lock the lower engagement portion 760 to the upper engagement portion 762. The securing mechanisms 768, 770 may be released by the push of a button 764, the pull of a lever, or the like. Once the lower shaft engagement portion 760 is secured to the upper shaft engagement portion 762, the shaft engagement section 720 may be rotated to grip the shaft, as explained above.

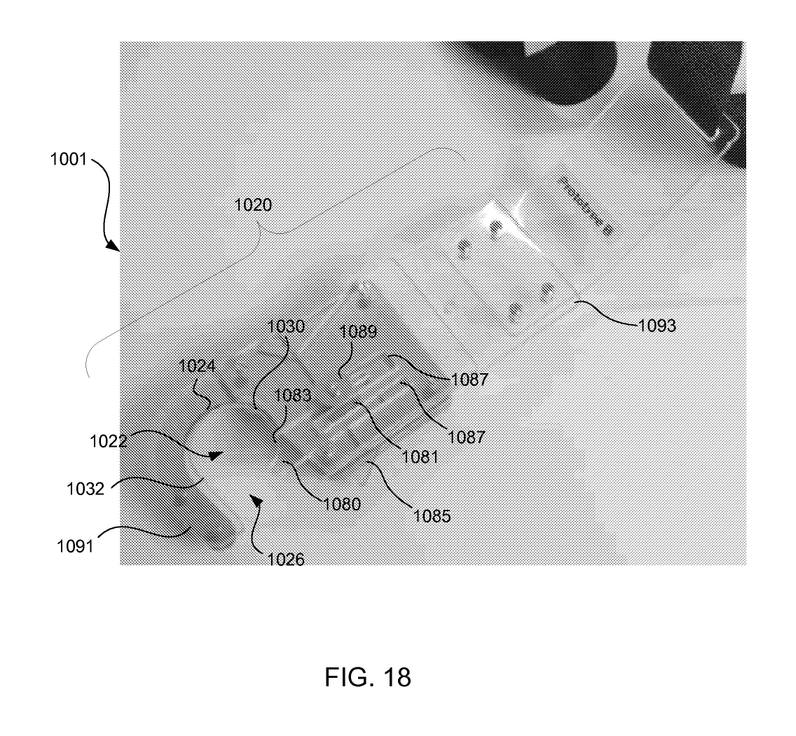

As shown in FIG. 18, a shaft coupler 1001 includes a shaft retaining member 1080. In this embodiment, a spring 1081 pushes the shaft retaining member 1080 into an extended position to help retain the shaft within in the aperture 1022, for example, when the shaft coupler is in a disengaged position with respect to the shaft. The shaft retaining member 1080 has an inner curved surface 1083 that may engage the outer surface of the shaft. For example, the curvature of the inner curved surface 1083 may substantially match the circumference and/or general geometric shape of the shaft. The shaft retaining member 1080 may have a length of 6.40 cm (+/−0.05 cm, 0.10 cm, 0.25 cm or more).

In some embodiments, the shaft coupler 1001 includes a lip (not shown) located at the distal end 1091 of the shaft coupler 1001. The lip enables a user to reach and lift the distal end 1091 of the shaft coupler 1001 and thereby rotate the shaft coupler away from its engaged position without lowering proximal end 1093 of the shaft coupler 1001.

As also shown in FIG. 18, the shaft coupler 1001 includes a knob 1089 that can be used to pull the shaft retaining member 1080 into a shaft retaining member aperture 1087. This action moves the shaft retaining member 1080, in whole or in part, out of the channel 1026 so that the shaft can more easily pass into the aperture 1022 through the channel 1026. Once the knob 1089 is released, the spring 1081 will push the shaft retaining member 1080 back into its extended position.

In some embodiments, the shaft coupler 1001 includes a slide stop 1085 that rotates from a disengaged position (as shown in FIG. 18) to an engaged position in which the securing member 1085 contacts the shaft within the aperture 1022. The slide stop 1085 may be coated with rubber or other friction-enhancing materials to increase its engagement with the shaft. The slide stop 1085 can be used to hold the shaft coupler 1001 at a particular location on the shaft when the shaft coupler 1001 is rotated away from its engaged position. In particular, when the shaft coupler 1001 is in its engaged position, the upper edge 1030 and the lower edge 1032 of the receiving aperture 1022 engage the shaft so that the shaft coupler 1001 lifts and carries the shaft. When the shaft coupler 1001 is rotated away from that engaged position, the upper edge 1030 and the lower edge 1032 of the receiving aperture 1022 no longer engage the shaft and the shaft coupler 1001 could slide down the shaft. However, if the slide stop 1085 is placed into its engaged position, the slide stop 1085 prevents or limits that sliding movement.

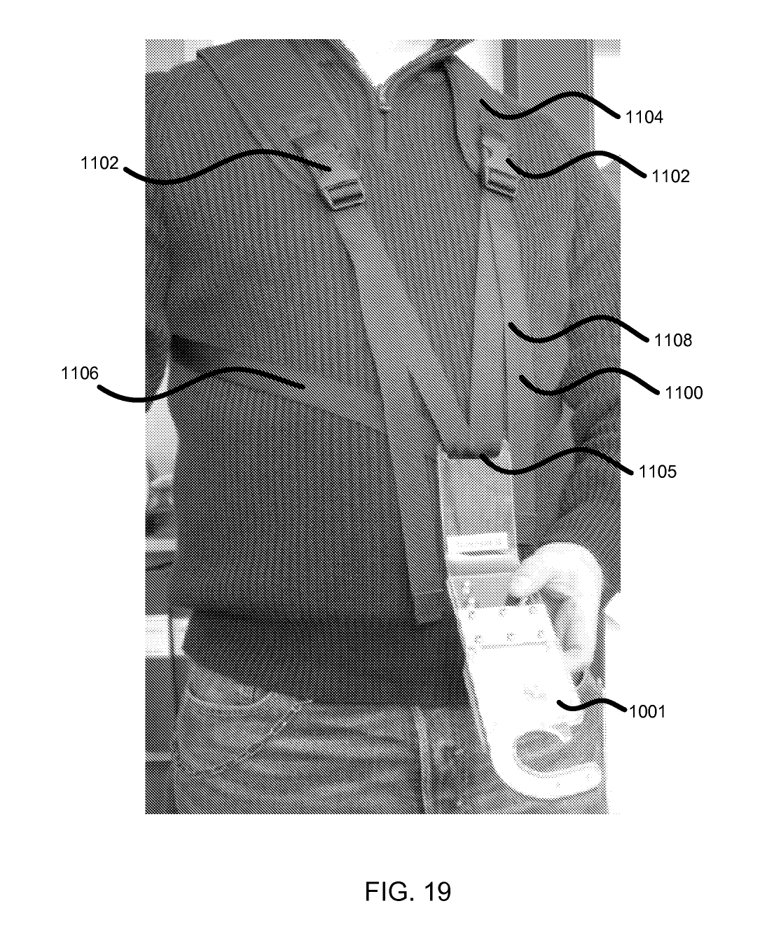

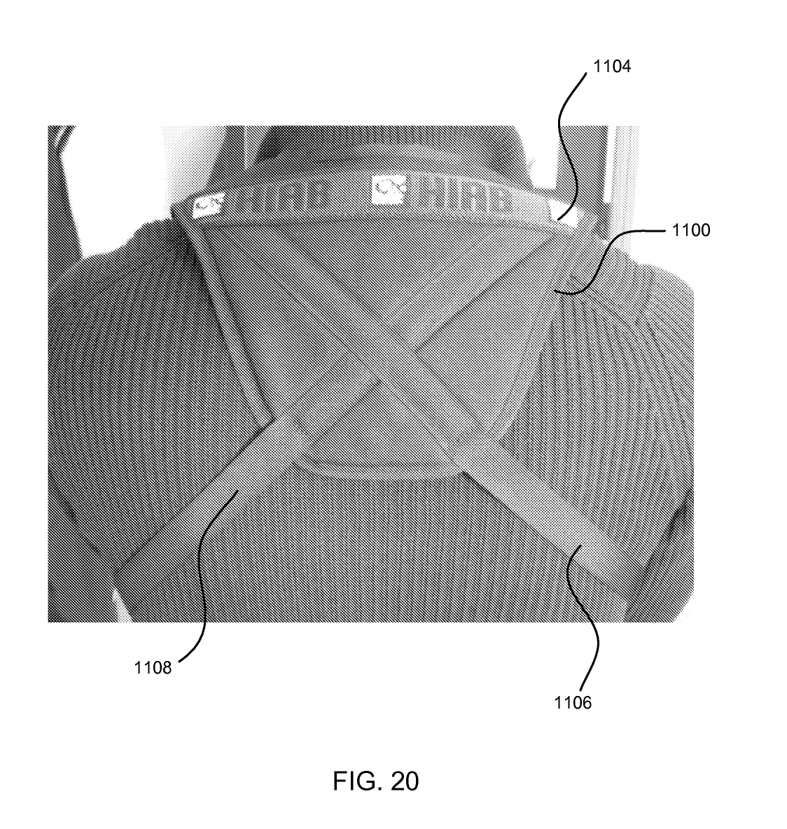

As shown in FIGS. 19-20, a shaft coupler 1001 may be coupled to a dual sided sling 1100. In particular, the dual sided sling 1100 includes buckles 1102 attached to a shoulder portion 1104. The buckles 1102 are also attached to sling straps 1106, 1108. In operation, the sling straps 1106, 1108 pass through one or more sling slots (e.g., sling slot 1105 in FIG. 19), wrap around the body, and connect with the shoulder portion 1104. In the embodiments shown in FIGS. 19-20, the sling straps are permanently connected to the shoulder portion 1104 but are adjustably and releasably connected to the buckles 1102. The shaft coupler 1001 and dual sided sling 1100 may be used in a manner similar to that described above to engage and transport a load bearing shaft.

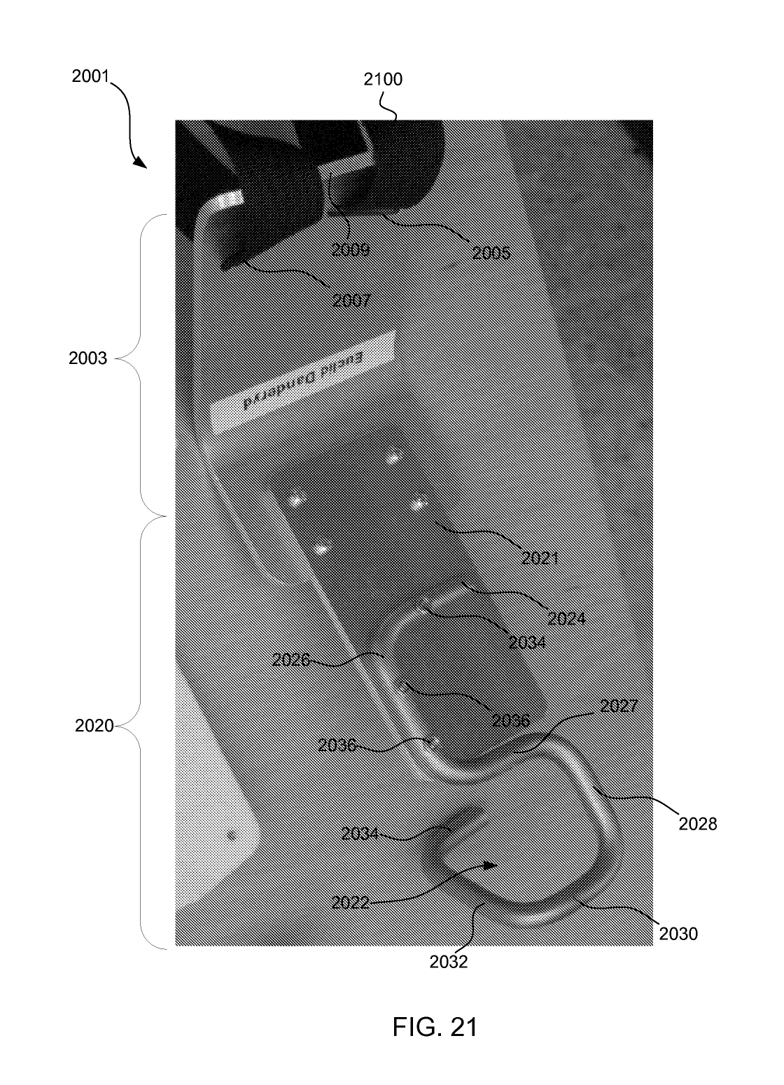

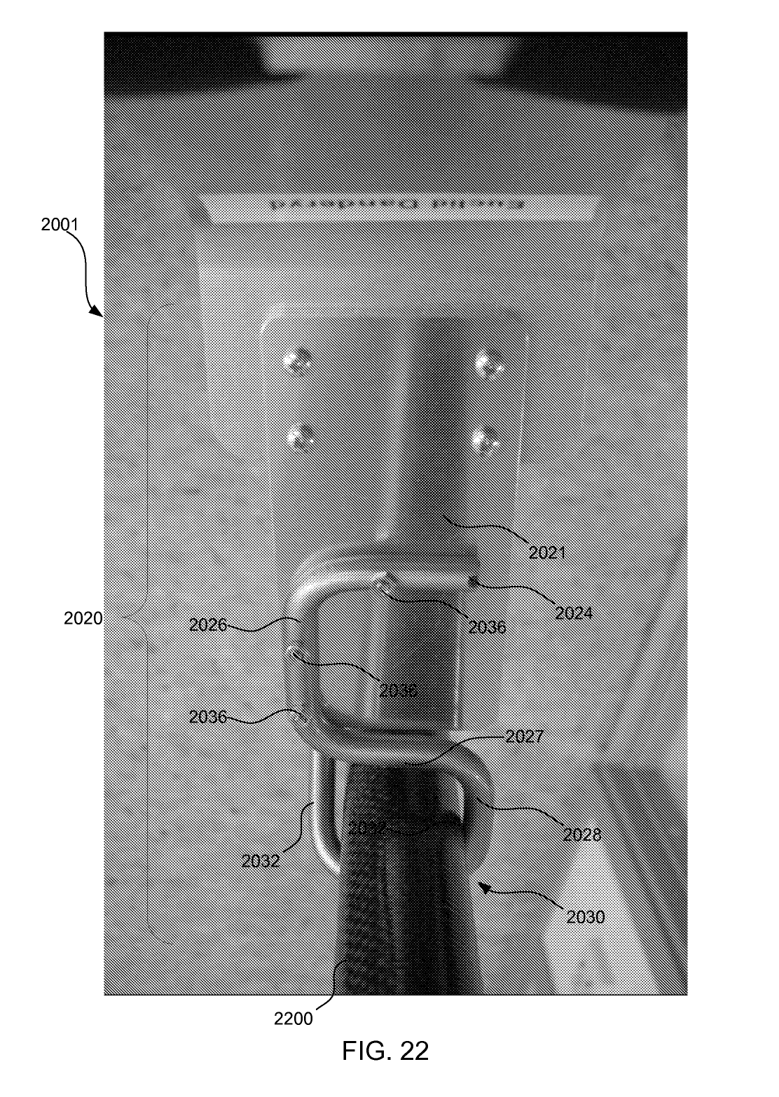

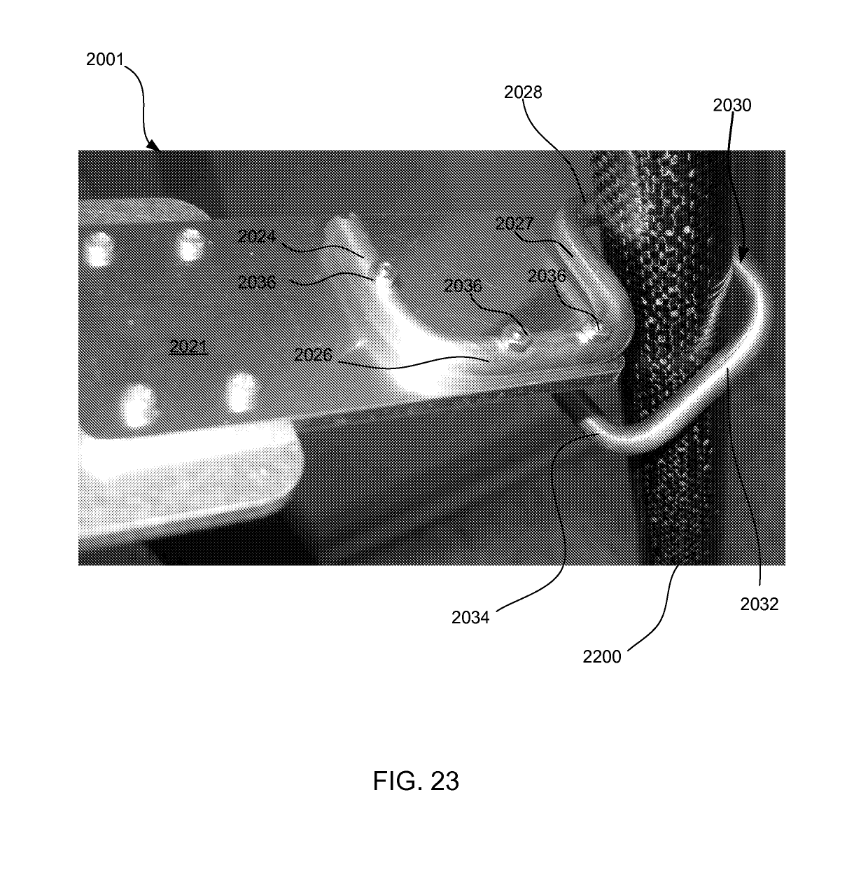

As shown in FIGS. 21-24, in some embodiments a shaft coupler 2001 includes an angled aperture member 2024 that forms an angled aperture 2022 to engage a shaft 2200. The size and shape of the angled aperture 2022 may be similar to the aperture 22 described above, and the size, shape, and composition of the angled aperture member 2024 may be similar to the size, shape, and composition of the shaft engagement section 20 (including, e.g., the friction-enhancing material discussed with respect to the upper edge 30 and lower edge 32).

In particular, the angled aperture member 2024 includes a first section 2026 that is coupled to an engagement plate 2021, for example, using screws 2034, 2036, welding, or the like. Alternatively, the angled aperture member 2024 may be unitarily formed with the engagement plate 2021. The angled aperture member 2024 also includes a second section 2027 that is substantially orthogonal to a third section 2028, which is in turn substantially orthogonal to a fourth section 2030. In some embodiments, a fifth section 2032 angles away from a plane in which the second, third, and fourth sections 2027, 2028, 2030 lie. The angle formed by the fourth section 2032 with that plane can range from 10° to 85°, though angles from approximately 25° to 65° are more preferred. A sixth section 2034 extends from the fifth section 2032. In some embodiments, the sixth section 2034 is substantially parallel to the second section 2027.

In some embodiments, the length, thickness, and/or composition of each of the sections of the angled aperture member 2024 are sized to correspond to the size, shape and/or composition of the shaft 2200. For example, in some embodiments, the length of the second section 2027 is 5.10 cm, the length of the third section 2028 is 5.50 cm, the length of the fourth section 2030 is 5.10 cm, the length of the fifth section 2032 is 6.20 cm, and the length of the sixth section 2034 is 4.00 cm. The distance from the sixth section 2034 to the second section 2027 is 6.00 cm, the distance from the sixth section 2034 to the fourth section 2030 is 6.60 cm, and the distance from the fifth section 2032 to the third section 2028 is 5.10 cm. In other embodiments, those lengths may vary (e.g., +/−0.10 cm, +/−0.50 cm, +/−1 cm, etc.) to accommodate shafts of varying sizes and/or compositions.

In some embodiments, when the shaft coupler 2001 engages the shaft 2200, the fourth section 2030 engages one side of the shaft 2200 in a manner similar to the lower edge 32 of the receiving aperture 22 discussed above. The second section 2027 may also engage the opposite side of the shaft 2200 in a manner similar to the upper edge 30 of the receiving aperture 22 discussed above. The third section 2028, the fifth section 2032, and the sixth section 2034 may be used to retain the shaft 2200 within the angled shaft aperture 2022, for example, when the shaft coupler 2001 is in a disengaged position. In some embodiments, the functions performed by the fifth section 2032 and the sixth section 2034 are similar to the functions performed by the shaft retaining member 1080 described above.

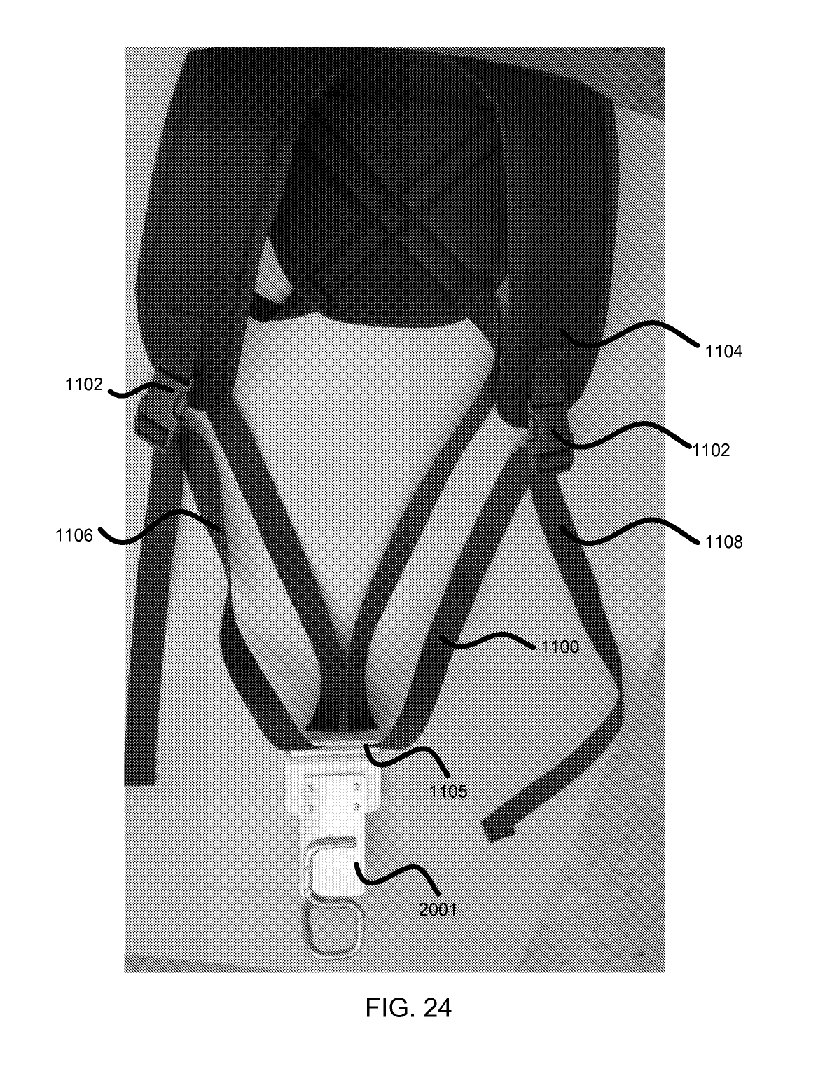

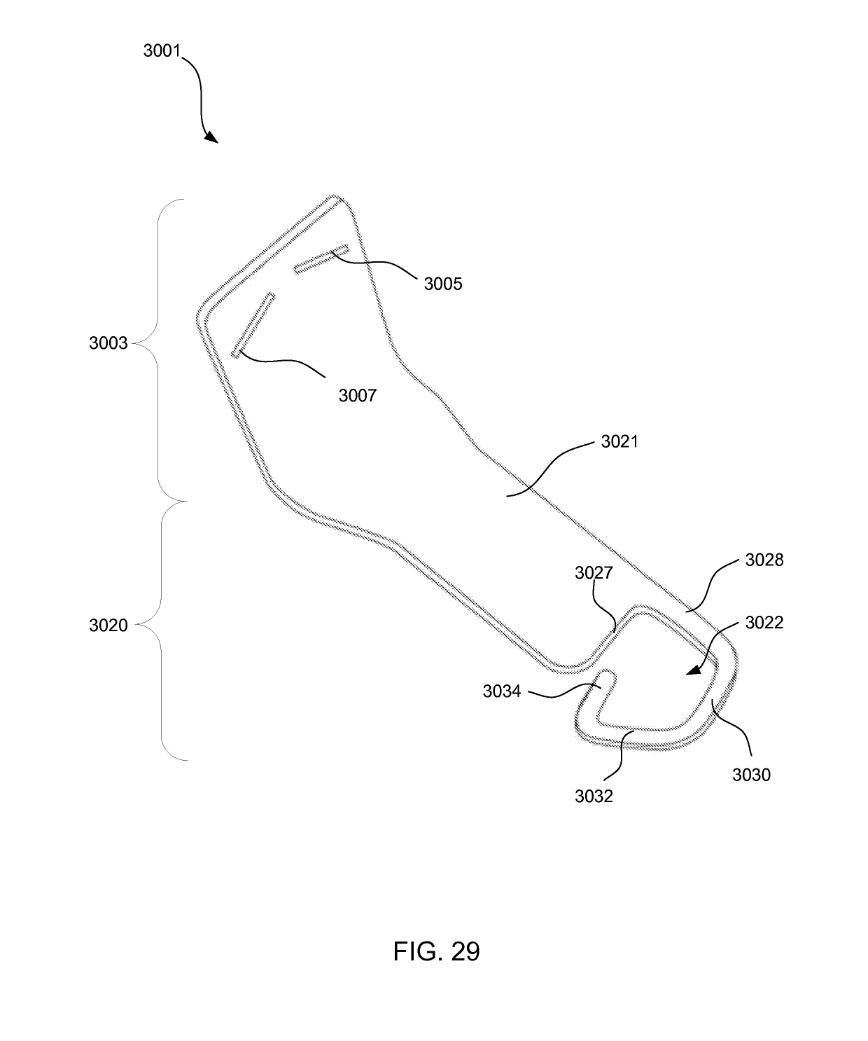

Exemplary methods for placing the shaft 2200 within the angled aperture 2022 are described below with respect to the embodiments shown in FIGS. 29-31. Once the shaft 2200 is within the angled aperture 2022, the shaft coupler 2001 may be rotated to engage and lift the shaft 2200 in a manner similar to that described above. The materials and/or coatings described above may be used with the shaft coupler 2001, and in particular with the angled aperture member 2024. As shown in FIG. 24, the shaft coupler 2001 can be coupled to a dual sided sling 1100 (or any other sling) in a manner similar to that described above.

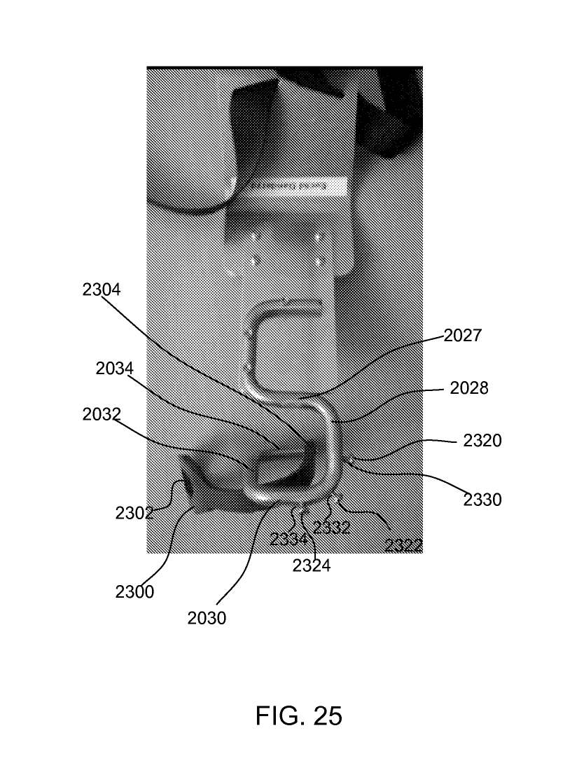

As shown in FIG. 25, the shaft coupler 2001 may include a leash 2300, which may be formed of rubber, silicone, a resilient plastic, or the like. In some embodiments, the leash 2300 adds supporting forces that help restrain movement of the shaft 2200. The leash 2300, in some embodiments, includes a user aperture 2302 and a shaft coupler aperture 2304. The shaft coupler aperture 2304 is sized to engage the shaft coupler 2001 (e.g., the sixth section 2304). For example, the leash 2300 may be formed of a resilient material and the shaft coupler aperture 2304 may be shaped to match the outer circumference of the sixth section 2034 but with a slightly smaller circumference. In that example, the shaft coupler aperture 2304 must stretch to accommodate the larger circumference, and the resilient forces help to secure the sixth section 2034 within the shaft coupler aperture 2304. The user aperture 2302 provides a handy interface for a user to contort the leash 2300 to a desired configuration. For example, the user may insert his or her finger into the user aperture 2302 and stretch the leash to a desired position and/or length.

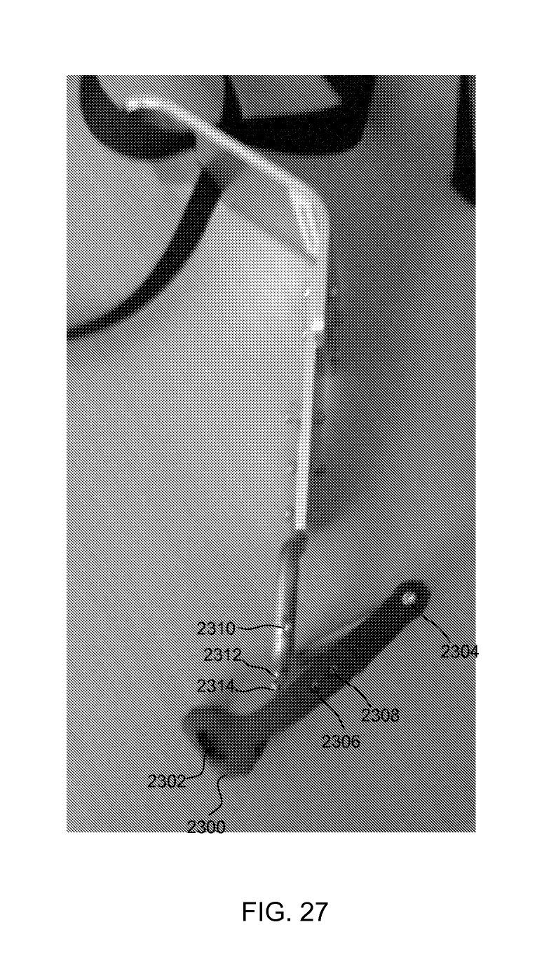

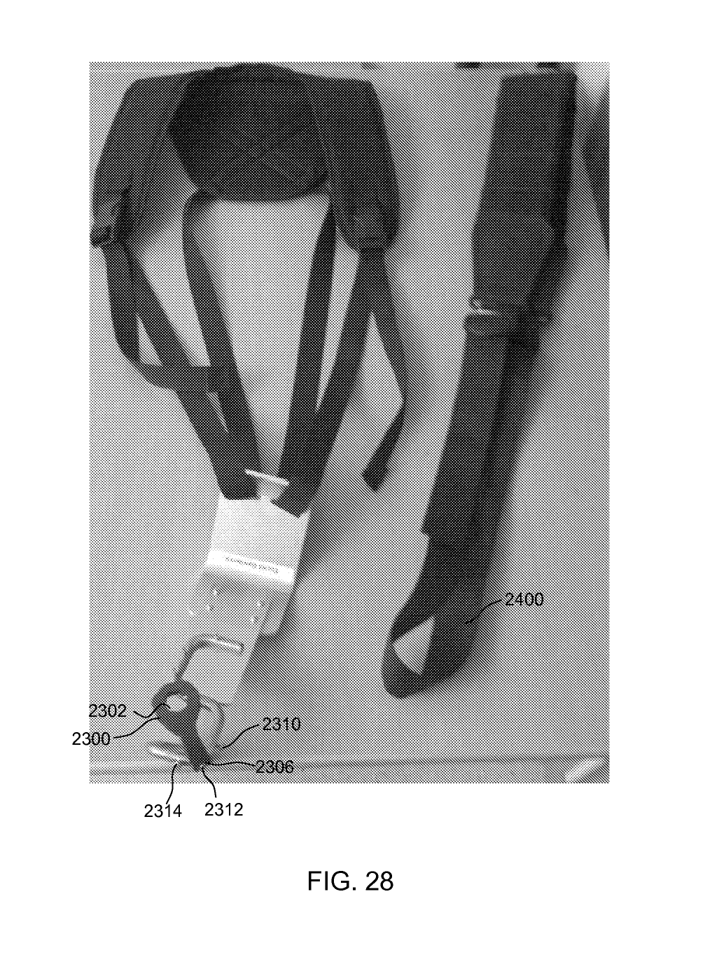

In some embodiments, for example as shown in FIG. 27, the leash includes support apertures 2306, 2308 designed to fit over protrusions 2310, 2312, and/or 2314 on the shaft coupler 2001. In some embodiments, the protrusions 2310, 2312, 2314 each include a head 2320, 2322, 2324 and a shoulder 2330, 2332, 2334, as shown in FIG. 25. The support apertures 2306, 2308 are smaller than the heads 2320, 2322, 2324 so that the support apertures 2306, 2308 must expand as they pass over one or more of the heads 2320, 2322, 2324. By passing a support aperture onto a protrusion, the leash is fixed at a particular angle to help support the shaft within the shaft coupler. For example, as shown in FIG. 28, the support aperture 2306 is on protrusion 2312 to add supplemental restraining forces on a shaft (not shown). In some embodiments, the user wraps the leash 2300 around the shaft and places the support aperture 2306 onto the protrusion 2312. The resilient material of the leash 2300 helps to secure the shaft within the angled receiving aperture 2322.

As also shown in FIG. 28, a single sided sling 2400 may be used in connection with a sling coupler. The specifics of the single sided sling 2400 may be similar to the sling 100 described above.

FIGS. 29-31 illustrate embodiments of a shaft coupler 3001 that incorporates an angled receiving aperture 3022. The shaft coupler 3001, in some embodiments, incorporates one or more of the features of the shaft couplers described above. Referring now to FIG. 29, the angled receiving aperture 3022 is partially bound by a first section 3027, a second section 3028, a third section 3030, a fourth section 3032, and a fifth section 3034. In some embodiments, one or more of the sections (e.g., the first section 3027, the second section 3028, and the third section 3030) reside in a plane while other sections (e.g., the fourth section 3032) form an angle with that plane. Each of the sections may be used to assert restraining forces (e.g., the second section 3028, the fourth section 3032, and the fifth section 3034) and/or lifting forces (e.g., the first section 3027 and the third section 3030) on a shaft. As shown in FIG. 29, the first section 3027 is unitarily formed with an engagement plate 3021, and may be formed of a rigid material. The other sections 3028, 3030, 3032, and 3034 may also be unitarily formed (e.g., out of a rigid material).

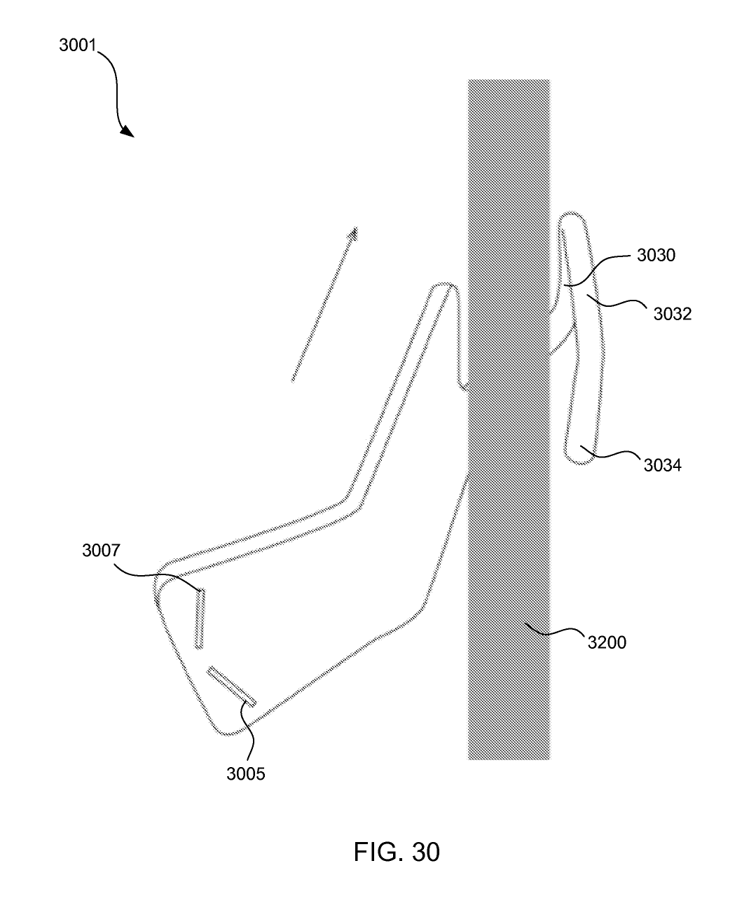

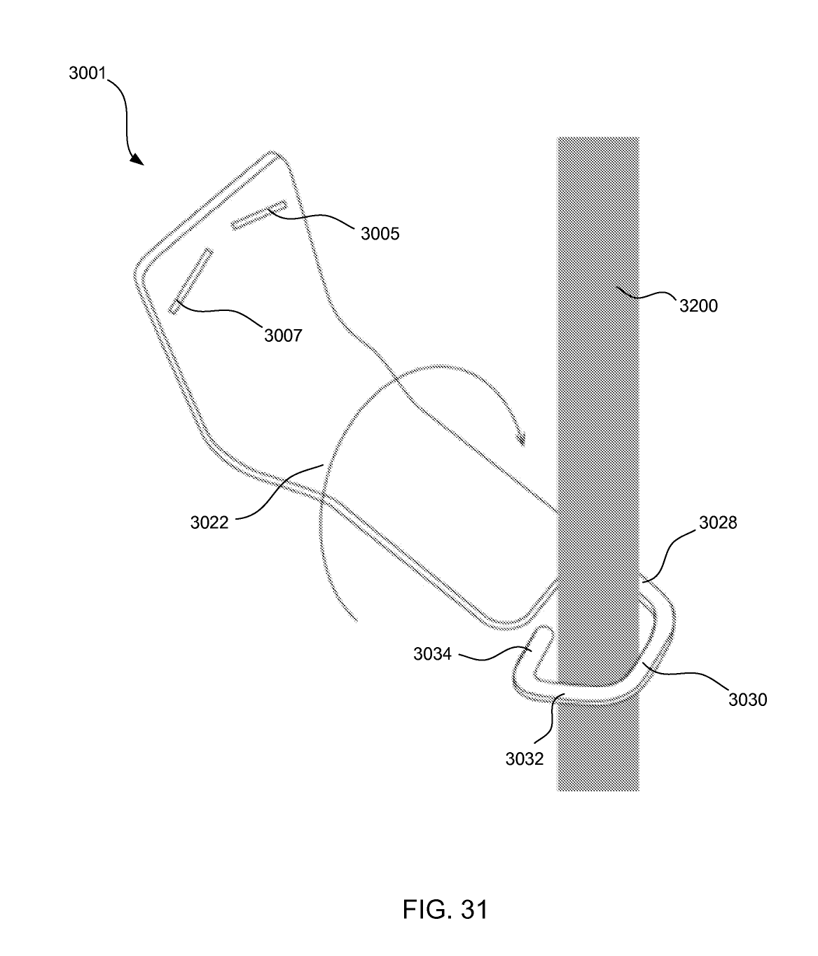

FIG. 30 illustrates how a shaft 3200 is placed into the angled receiving aperture 3022. Specifically, the shaft coupler 3001 is rotated with respect to the shaft 3200 so that the fifth section 3034 and the first section 3027 are on opposite sides of the shaft 3200. In some embodiments, the shaft coupler 3001 may be rotated from 15° to 90° or more, though angles of 90° (+/−25°) are generally preferred. The shaft coupler 3001 is then moved toward the shaft 3200 so that the shaft 3200 enters the angled receiving aperture 3022. As shown in FIG. 31, the shaft coupler 3001 is rotated back to its initial orientation. In that orientation the fifth section 3034 and the first section 3027 are on the same side of the shaft 3200. The shaft coupler 3001 may then rotate to engage the shaft (using, e.g., the third section 3030 and the first section 3027) in a similar manner as described above.

In some embodiments (not shown), the first, second, third, fourth, and/or fifth sections 3027, 3028, 3030, 3032, 3034 form a continual curve, such that the angled receiving aperture 3022 is at least partially bound by a helix or a partial helix. The curvature (i.e., arc) of that continual curve, in some embodiments, may match the curvature of the outer surface of the shaft 3200 for a tight fit or may be larger for a more loose fit. The continual curve or helix places a curved surface against the shaft 3200, rather than a sharp edge. In some embodiments, the outer surface of the first, second, third, fourth, and/or fifth sections 3027, 3028, 3030, 3032, 3034 may be concave or flat so as to increase the surface area of those sections that contact the shaft 3200.

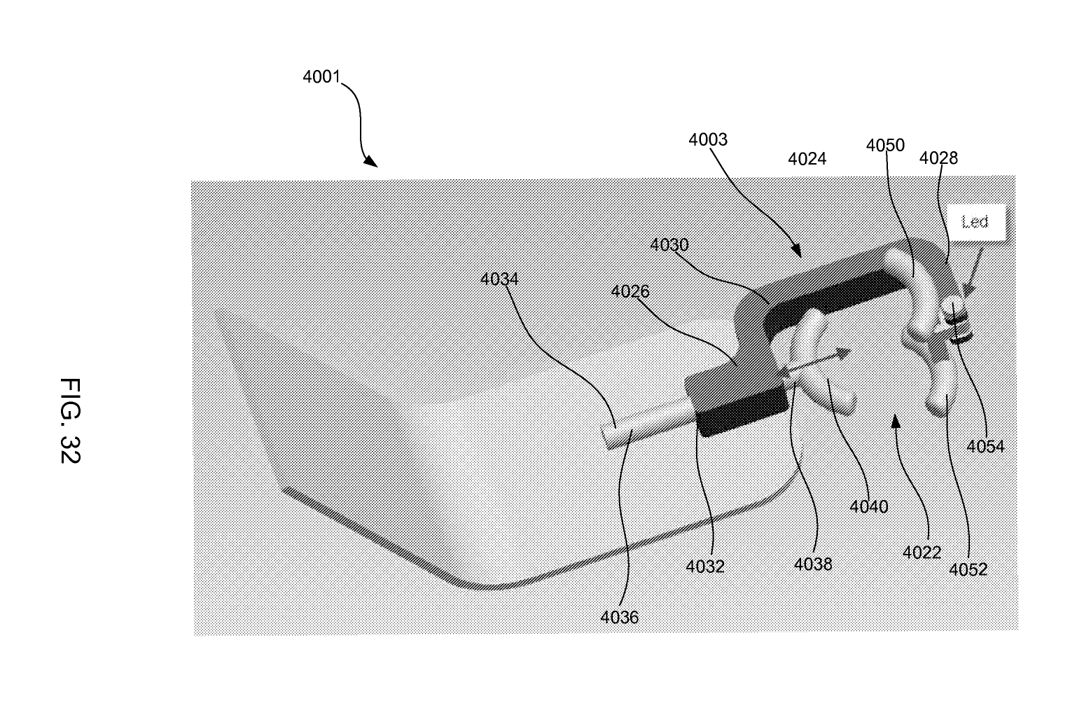

FIG. 32 illustrates a shaft coupler 4001 that includes a shaft retaining mechanism 4003 that partially defines a receiving aperture 4022. The shaft retaining mechanism 4003 includes a support bar 4024 that has a proximal portion 4026, a distal portion 4028, and an intermediate portion 4030 connected to the proximal portion 4026 and to the distal portion 4028. These portions 4024, 4026, 4028 may be substantially straight or curved and may form acute, right, or obtuse angles with each other.

The proximal portion 4026 includes an aperture 4032 through which a proximal portion 4034 of a proximal clamp member 4036 extends. The distal portion 4038 of the proximal clamp member 4036 includes a shaft engagement interface 4040. In some embodiments, the shaft engagement interface 4040 includes a curved surface that matches the curvature of the shaft and may be formed or coated with friction-enhancing materials, such as rubber or the like.

The shaft retaining mechanism 4003 further includes an upper distal clamp member 4050 and a lower distal claim member 4052. The upper distal clamp member 4050 is coupled (either directly or indirectly) to the distal portion 4028 of the support bar 4024 and the lower distal clamp member 4052 is coupled (either directly or indirectly) to the distal portion 4028 of the support bar 4024.

In some embodiments, the shaft retaining mechanism is placed into an “open” configuration in which the proximal clamp member 4036 is placed away from the upper distal clamp member 4050 and the lower distal clamp member 4052. A shaft is then inserted into the receiving aperture 4022. The proximal clamp member 4036 then slides towards the distal clamp members 4050, 4052, such that the shaft engagement interface 4040 contacts one side of the shaft and the distal clamp members 4050, 4052 contact the opposite side of the shaft. The proximal clamp member 4036 is then secured in that “closed” position. In some embodiments, the upper distal clamp member 4050 and/or the lower distal clamp member 4052 are operatively coupled to an LED 4054, which lights up when the shaft retaining mechanism 4003 has secured a shaft within the receiving aperture 4022.

The proximal clamp member 4036 may be secured by various lock mechanisms that are, for example, incorporated into the proximal portion 4026 of the support bar 4024. In some embodiments, the lock mechanism may secure the clamp member 4036 once a load (e.g., forces provided by engagement of the shaft with the shaft engagement interface 4040) is placed on the clamp member 4036, while in other embodiments the lock mechanism may secure the clamp member at any time and/or position(s). In some embodiments, the proximal clamp member 4036 may be used in combination with other components of other embodiments, such as the angled aperture member 2024.

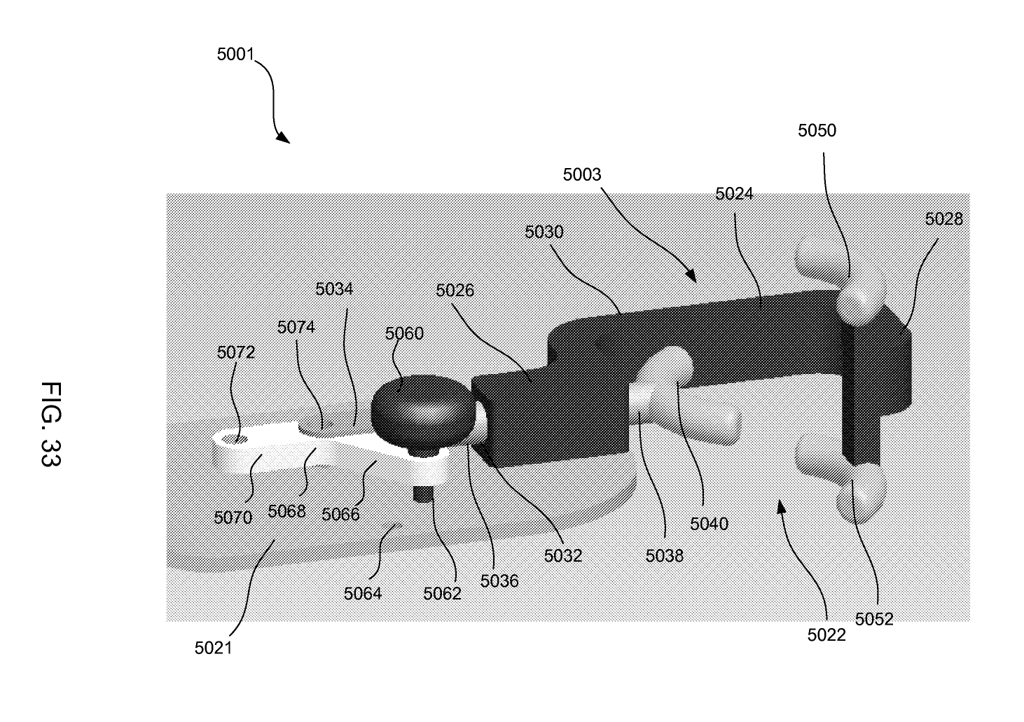

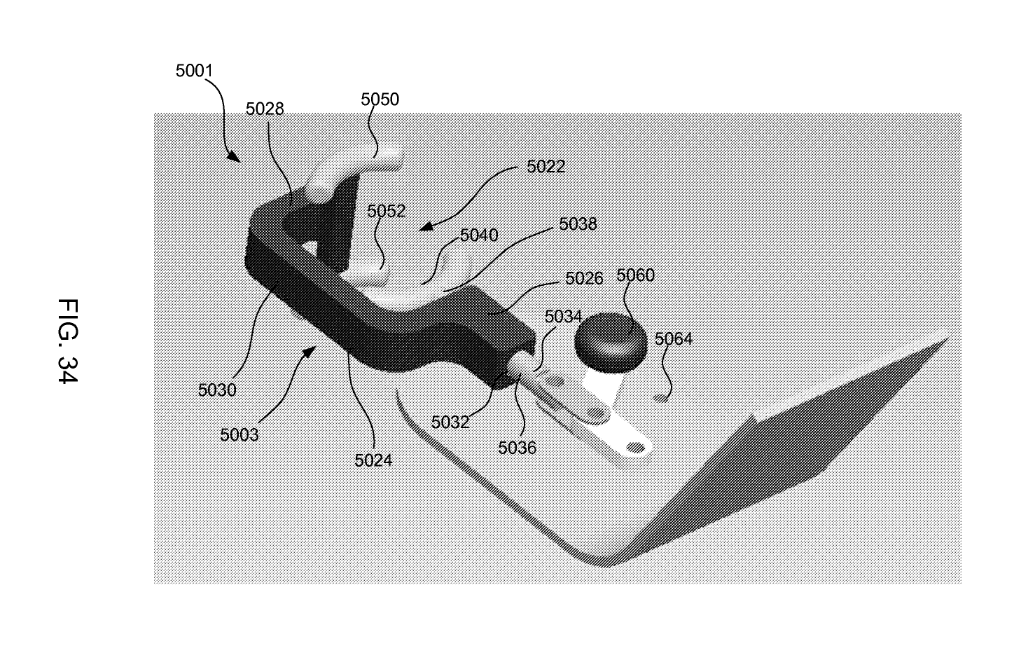

In the embodiments shown in FIGS. 33 and 34, a lock mechanism 5060 includes a locking pin 5062 that engages a lock aperture 5064, so that a proximal clamp member 5036 is locked at a particular position. The engagement plate 5021 can include multiple lock apertures 5064 located at various locations so that the proximal clamp member 5036 may be secured at various positions. In some embodiments, the locking pin 5062 is joined to a locking handle 5060 and placed through a first aperture 5064 located in a first section 5066 of a pivot bar 5068. A second section 5070 of the pivot bar 5068 is pivotally coupled to the engagement plate 5021, for example, using aperture 5072. The pivot bar 5068 is pivotally coupled to the proximal clamp member 5036 at the juncture 5074 between the first section 5066 and the second section 5070 of the pivot bar 5068. As a result, as the locking handle 5060 is moved along an arc, the proximal clamp member 5036 moves along a line towards and away from the distal clamp members 5050, 5052. As the locking pin 5062 passes over and/or into each lock aperture 5064, the locking handle 5060 can lift the locking pin 5062 away from each lock aperture 5064.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A device for ergonomically transporting a load-bearing shaft, the device comprising:
a sling attachment section adapted to couple with a sling;
a shaft engagement section adapted to engage a shaft, the shaft engagement section comprising a shaft receiving aperture defined by an inner surface,
wherein the inner surface includes a first edge and a second edge that is opposite the first edge,
wherein the first edge of the inner surface is adapted to frictionally engage a first portion of an outer surface of the shaft,
wherein the second edge of the inner surface is adapted to frictionally engage a second portion of an outer surface of the shaft that is opposite from the first portion of the outer surface of the shaft, and
wherein the frictional engagement between the first edge and the shaft and the second edge and the shaft is sufficient to lift the shaft when the device is lifted.

2. The device of claim 1, wherein the first edge and the second edge are each formed of a rigid material.

3. The device of claim 1, wherein the shaft engagement section further comprises a channel extending from the shaft receiving aperture to an outer surface of the shaft engagement section.

4. The device of claim 3, wherein the channel extends from the shaft receiving aperture to the outer surface of the shaft engagement section along a substantially straight line and wherein a surface defining the channel forms an angle with the inner surface defining the shaft receiving aperture that is greater than 180 degrees.

5. The device of claim 3, wherein a surface defining the channel forms a non-orthogonal angle with a line drawn between the first edge and the second edge.

6. The device of claim 3, wherein the shaft engagement section includes at least one segment at least partially extending into the channel.

7. The device of claim 6, wherein an outer surface of the segment is formed from a resilient material.

8. The device of claim 1, wherein the shaft engagement section comprises a shaft retaining member that includes a locking member that is configured to secure the shaft retaining member in a locked position.

9. The device of claim 1, wherein the device does not permit flexion of the first or second edges with respect to each other.

10. The device of claim 1, further comprising a shaft retaining member configured to move towards the shaft and into an engaged position with respect to the shaft.

11. The device of claim 1, wherein the first edge of the inner surface of the shaft engagement section is adapted to frictionally engage the first portion of the outer surface of the shaft at a location that is at a different height than a location at which the second edge of the inner surface of the shaft engagement section engages the second portion of the outer surface of the shaft.

12. A method of ergonomically transporting a load-bearing shaft, comprising:
inserting a shaft through a channel and into an interior aperture of a pole hook;
rotating the pole hook to frictionally engage a rigid inner surface of the interior aperture with a rigid outer surface of the shaft; and
raising the pole hook to lift the shaft using the frictional engagement.

13. The method of claim 12, wherein inserting the shaft through the channel and into the interior aperture of the pole hook comprises:
placing a plane defined by an upper surface of the pole hook in a substantially orthogonal position with respect to a longitudinal axis of the shaft; and
while maintaining the plane in the substantially orthogonal position with respect to the longitudinal axis of the shaft, inserting the shaft through the channel and into the interior aperture of the pole hook.

14. The method of claim 13, wherein rotating the pole hook to frictionally engage the rigid inner surface of the interior aperture with the outer surface of the shaft comprises:
rotating the plane into a substantially non-orthogonal position with respect to the longitudinal axis of the shaft to frictionally engage the rigid inner surface of the interior aperture with the outer surface of the shaft.

15. The method of claim 14, further comprising:
attaching the pole hook to a sling;
securing the sling to a central portion of a body; and
raising the central portion of the body to rotate the plane into the substantially non-orthogonal position with respect to the longitudinal axis of the shaft and to frictionally engage the rigid inner surface of the interior aperture with the outer surface of the shaft.

16. The method of claim 12, further comprising:
moving a shaft retaining member towards the shaft and into an engaged position in which the shaft engagement mechanism contacts the shaft.

17. A system for surveying a location using a pole coupled to a GPS unit, the system comprising:
a sling adapted to be secured to a central portion of a body; and
a pole coupler connected to the sling, wherein the pole coupler includes a channel extending from an outer surface of the pole coupler to an inner aperture, wherein the inner aperture is adapted to partially surround a pole inserted through the channel into the inner aperture, and wherein the inner aperture includes an inner surface configured to frictionally engage the inserted pole at two radially separated sides of the inserted pole.

18. The system of claim 17, wherein the pole coupler is adapted to be releasably secured to the sling in a first orientation in which a first surface of the pole coupler faces upwardly and wherein the pole coupler is adapted to be releasably secured to the sling in a second orientation in which the first surface of the pole coupler faces downwardly.

19. The system of claim 17, wherein a dimension of the channel and a dimension of the inner aperture are each less than 2 cm larger than a maximum cross-sectional dimension of the pole.

20. The system of claim 17, wherein the pole coupler includes a proximal end and a distal end, wherein the distal end is heavier than the proximal end, and wherein the proximal and the distal ends are substantially non-coplanar.
